(19) United States
(12) Patent Application Publication
(10) Pub. No.: US 2012/0213052 A1
(43) Pub. Date: Aug. 23, 2012

(54) OPTICAL HEAD, OPTICAL DISC DEVICE, INFORMATION PROCESSING DEVICE, AND OBJECTIVE LENS

(76) Inventors: Fumitomo Yamasaki, Nara (JP); Katsuhiko Hayashi, Nara (JP); Yoshiaki Komma, Osaka (JP)

(21) Appl. No.: 13/504,602

(22) PCT Filed: Dec. 6, 2010
(86) PCT No.: PCT/JP2010/007084

§ 371 Date: Apr. 27, 2012

(30) Foreign Application Priority Data
Dec. 24, 2009 (JP) 2009-291707

(51) Int. Cl. G11B 7/135

(52) U.S. Cl. 369/112.05; G9B/7.112

(57) ABSTRACT

Provided are an optical head capable of favorably recording or reproducing information to or from an information recording medium including a plurality of information recording surfaces, an optical disc device including the optical head, an information processing device including the optical disc, and an objective lens. The optical head (40) includes a blue-violet laser light source (1) which emits a blue-violet laser beam, an objective lens (8) which has an orbicular zone-shaped diffractive structure, and which diffracts the blue-violet laser beam and converges the generated diffracted light of n-th order (where n is a natural number) on a predetermined information recording surface of a multi-layer optical disc (60), and a light-receiving element (23) which receives the blue-violet laser beam reflected by the predetermined information recording surface, wherein the diffractive structure adds a positive power component and a spherical aberration component to the n-th order diffracted light.

### TECHNICAL FIELD

The present invention relates to an optical head which records or reproduces information to or from an information recording medium such as an optical disc, an optical disc device having the foregoing optical head, an information processing device having the foregoing optical disc device, and an objective lens for use in the foregoing optical head.

### BACKGROUND ART

Pursuant to the practical application of a blue-violet semiconductor laser, a Blu-ray Disc (hereinafter referred to as a “BD”) as an optical information recording medium (hereinafter also referred to as an “optical disc”) of the same size as a Compact Disc (CD) and a DVD and having high density and large capacity has been put into practical application.

A BD is an optical disc which is used for recording or reproducing information to and from an information recording surface in which the thickness of the light transmitting layer is approximately 100 μm by using a blue-violet laser light source which emits a blue-violet laser beam having a wavelength of roughly 405 nm, and an objective lens in which the numerical aperture (NA) is approximately 0.85. As the BD, a single layer disc with one information recording surface and a dual layer disc with two information recording surfaces have been put into practical application, and the storage capacity of one layer is approximately 25 GB.

With a high density optical disc such as a BD which uses a blue-violet laser beam of a short wavelength and an objective lens with a high NA, the wavelength of the laser beam that is emitted from the light source changes pursuant to the drastic change in the emission power of the laser beam associated with the switching between recording and reproduction. Consequently, the refractive index of the objective lens will change, and a misalignment (defocus) of the focal point of the objective lens will arise. This defocus caused by the wavelength change is referred to as a longitudinal chromatic aberration.

For example, Patent Literature 1 discloses an optical element comprising a diffractive structure or an optical head which uses an objective lens comprising the diffractive structure shown in FIG. 26 in order to inhibit the longitudinal chromatic aberration. FIG. 26 is a diagram schematically showing the shape of a conventional objective lens. With the foregoing optical element or objective lens, a diffractive structure is formed on a concentric circle, and the diffractive structure applies a (positive) power component of a convex lens to the diffracted light.

When the wavelength of the laser beam increases, the diffraction angle at the diffractive surface increases and the convex power intensifies, and when the wavelength of the laser beam decreases, the diffraction angle at the diffractive surface decreases and the convex power weakens. These phenomena function to offset the defocus arising due to the change in the refractive index of the objective lens associated with the wavelength change, and correct the longitudinal chromatic aberration.

Here, when an optical element comprising a diffractive structure or an optical lens comprising a diffractive structure is used, diffracted light of n-th order (where n is a natural number) which forms an optical spot for recording or reproduction is generated and, simultaneously, useless diffracted light of an adjacent order (for example, (n+1)-th order, (n+2)-th order, (n−1)-th order, (n−2)-th order or the like) is also generated. Such useless diffracted light forms an optical spot at a position that is different from the n-th order diffracted light, and is reflected by the information recording surface to be subject to recording or reproduction, by an information recording surface other than the information recording surface to be subject to recording or reproduction, or by the surface of the optical disc.

The useless diffracted light that is reflected by the information recording surface to be subject to recording or reproduction, by an information recording surface other than the information recording surface to be subject to recording or reproduction, or by the surface of the optical disc generates an interference upon overlapping with the signal light (that is, the n-th order diffracted light reflected by the information recording surface to be subject to recording or reproduction) and the light-receiving element, and it is known that this deteriorates the quality of the information signal and the servo signal.

Thus, for instance, Patent Literature 2 discloses an optical head which defines the position of the optical spot generated by the useless diffracted light so that the useless diffracted light generates a considerable defocus on the light-receiving element.

Meanwhile, in recent years, a multi-layer optical disc in which the information recording surface of a high density optical disc such as a BD is a multi-layer structure of three or more layers is being considered for an even greater capacity of optical discs.

With a multi-layer optical disc, the number of information recording surfaces to be subject to recording or reproduction is greater than a conventional optical disc. FIG. 27 is a diagram showing the schematic configuration of a conventional multi-layer optical disc. Table 1 shown below is a table representing the spacing between the surface of the optical disc and the information recording surfaces in a conventional multi-layer optical disc.

In FIG. 27, the spacing t0 between the surface 161 of the optical disc and the information recording surface L0 is 100 μm, the spacing t1 between the surface 161 of the optical disc and the information recording surface L1 is 84 μm, the spacing t2 between the surface 161 of the optical disc and the information recording surface L2 is 61 μm, and the spacing t3 between the surface 161 of the optical disc and the information recording surface L3 is 50 μm.

For example, with the multi-layer optical disc 160 having the structure shown in FIG. 27, as shown in Table 1 below, the spacing between the surface 161 of the optical disc and the other information recording surfaces L0 to L3 during the recording or reproduction of the information recording surfaces L0 to L3 will assume a value that is broadly distributed in range of −50 μm to +100 μm. Accordingly, in an optical head which uses an optical element comprising a diffractive structure or an objective lens comprising a diffractive structure, no matter how the position of the optical spot of the useless diffracted light is defined, when giving consideration even to the variation in the thickness of the light transmitting layer (for instance, ±5 μm), there are cases when the focusing of useless diffracted light on the light-receiving element is unavoidable.

TABLE 1

| | INFORMATION | INFORMATION | INFORMATION | INFORMATION |
|---|---|---|---|---|
| | RECORDING | RECORDING | RECORDING | RECORDING |
| | SURFACE L3 | SURFACE L2 | SURFACE L1 | SURFACE L0 |
| | t3 = 50 μm | t2 = 61 μm | t1 = 84 μm | t0 = 100 μm |
| SURFACE | +50 | +61 | +84 | +100 |
| INFORMATION | | +11 | +34 | +50 |
| RECORDING | | | | |
| SURFACE L3 | | | | |
| INFORMATION | −11 | | +23 | +39 |
| RECORDING | | | | |
| SURFACE L2 | | | | |
| INFORMATION | −34 | −23 | | +16 |
| RECORDING | | | | |
| SURFACE L1 | | | | |
| INFORMATION | −50 | −39 | −16 | |
| RECORDING | | | | |
| SURFACE L0 | | | | |

[UNIT: μm]

### CITATION LIST

### Patent Literature

Patent Literature 1: Japanese Patent Application Publication No. 2001-319368
Patent Literature 2: Japanese Patent Application Publication No. H9-44856

### SUMMARY OF INVENTION

The present invention was devised in view of the foregoing problems, and an object of this invention is to provide an optical head, an optical disc device, an information processing device and an objective lens capable of favorably recording or reproducing information to or from an information recording medium including a plurality of information recording surfaces.

The optical head according to one aspect of the present invention is an optical head for recording or reproducing information to or from an information recording medium including a plurality of information recording surfaces, this optical head including: a light source which emits a laser beam; an objective lens which has an orbicular zone-shaped diffractive structure, and which diffracts the laser beam and converges the generated diffracted light of n-th order (where n is a natural number) on a predetermined information recording surface of the information recording medium; and a photodetector which receives the laser beam reflected by the predetermined information recording surface, wherein the diffractive structure adds a positive power component and a spherical aberration component to the n-th order diffracted light.

According to the foregoing configuration, the light source emits a laser beam. The objective lens has an orbicular zone-shaped diffractive structure, and diffracts the laser beam and converges the generated diffracted light of n-th order (wherein n is a natural number) on a predetermined information recording surface of the information recording medium. The photodetector receives the laser beam that was reflected by the predetermined information recording surface. In addition, the diffractive structure adds a positive power component and a spherical aberration component to the n-th order diffracted light.

According to the present invention, since a positive power component is added to the n-th order diffracted light, the longitudinal chromatic aberration can be corrected, and since a spherical aberration component is added to the n-th order diffracted light, the diffracted stray light that is reflected by an information recording surface other than the predetermined information recording surface will not be focused at one point due to the spherical aberration component, it is possible to reduce the interference of the signal light and the diffracted stray light, and thereby favorably record or reproduce information to or from an information recording medium including a plurality of information recording surfaces.

The object, features and advantages of the present invention will become more apparent from the ensuing detailed explanation and appended drawings.

### BRIEF DESCRIPTION OF DRAWINGS

FIG. 1 is a diagram showing the schematic configuration of the optical head in Embodiment 1 of the present invention.

FIG. 2 is a diagram showing the schematic configuration of the multi-layer optical disc in Embodiment 1 of the present invention.

FIG. 3 is a view showing a frame format of the schematic configuration of the objective lens actuator in Embodiment 1 of the present invention.

FIG. 4 is a view showing a frame format of the schematic configuration of the collimating lens actuator in Embodiment 1 of the present invention.

FIG. 5A is a diagram showing the outgoing light when the collimating lens is in the reference position, FIG. 5B is a diagram showing the outgoing light when the collimating lens moves to the light source side, and FIG. 5C is a diagram showing the outgoing light when the collimating lens moves to the objective lens side.

FIG. 6 is a diagram schematically showing the shape of the objective lens in Embodiment 1 of the present invention.

FIG. 7 is a schematic diagram showing the appearance where a blue-violet laser beam is converged on the information recording surface L2 of the multi-layer optical disc by using the objective lens of Embodiment 1 of the present invention.

FIG. 8A to FIG. 8C are diagrams showing the appearance of light-focusing spots on the light-receiving element in Embodiment 1 of the present invention.

FIG. 9 is a schematic diagram showing the appearance where the +1st order light and the +2nd order light are converged on the multi-layer optical disc, when the light-focusing spot is formed on the light-receiving element without the +2nd order light being converged on the information recording surface, in Embodiment 1 of the present invention.

FIG. 10 is a diagram showing the relation between the spherical aberration characteristics based on the diffractive lens structure, and the third spherical aberration and the fourth spherical aberration which occur due to the temperature change in Embodiment 1 of the present invention.

FIG. 11 is a diagram showing the relation between the spherical aberration characteristics based on the diffractive lens structure, and the fifth spherical aberration which occurs due to the individual variability of the light source wavelength in Embodiment 1 of the present invention.

FIG. 12 is a diagram showing the relation between the spherical aberration characteristics based on the diffractive lens structure, and the amount of spherical aberration (total spherical aberration) to be corrected which occurs due to the temperature change and the individual variability of the light source wavelength in Embodiment 1 of the present invention.

FIG. 13 is a diagram showing the relation between the minimum pitch of the orbicular zone pattern of the diffractive lens structure, and the amount of spherical aberration (total spherical aberration) to be corrected which occurs due to the temperature change and the individual variability of the light source wavelength when the longitudinal chromatic aberration characteristics are set to 0.1 μm/nm in Embodiment 1 of the present invention.

FIG. 14 is a diagram showing the relation between the minimum pitch of the orbicular zone pattern of the diffractive lens structure and the total spherical aberration when the tolerable range of the individual variability of the light source wavelength is expanded in comparison to FIG. 13.

FIG. 15 is a diagram explaining a specific example of the objective lens in Embodiment 1 of the present invention.

FIG. 16 is a diagram showing the optical path in the objective lens having the diffractive structure of Example 1.

FIG. 17 is a graph representing the longitudinal aberration (spherical aberration) when parallel light enters the objective lens in the objective lens having the diffractive structure of Example 1.

FIG. 18 is a diagram showing the optical path in the objective lens having the diffractive structure of Example 2.

FIG. 19 is a graph representing the longitudinal aberration (spherical aberration) when parallel light enters the objective lens in the objective lens having the diffractive structure of Example 2.

FIG. 20 is a diagram showing the optical path in the objective lens having the diffractive structure of Example 3.

FIG. 21 is a graph representing the longitudinal aberration (spherical aberration) when parallel light enters the objective lens in the objective lens having the diffractive structure of Example 3.

FIG. 22 is a diagram showing the schematic configuration of the optical disc device in Embodiment 2 of the present invention.

FIG. 23 is a diagram showing the schematic configuration of the computer in Embodiment 3 of the present invention.

FIG. 24 is a diagram showing the schematic configuration of the optical disc player in Embodiment 4 of the present invention.

FIG. 25 is a diagram showing the schematic configuration of the optical disc recorder in Embodiment 5 of the present invention.

FIG. 26 is a diagram schematically showing the shape of a conventional objective lens.

FIG. 27 is a diagram showing the schematic configuration of a conventional multi-layer optical disc.

### DESCRIPTION OF EMBODIMENTS

The optical head, the optical disc device and the objective lens according to the embodiments of the present invention are now explained with reference to the drawings. Note that the ensuing embodiments are merely examples that embody the present invention, and are not intended to limit the technical scope of the present invention in any way.

### Embodiment 1

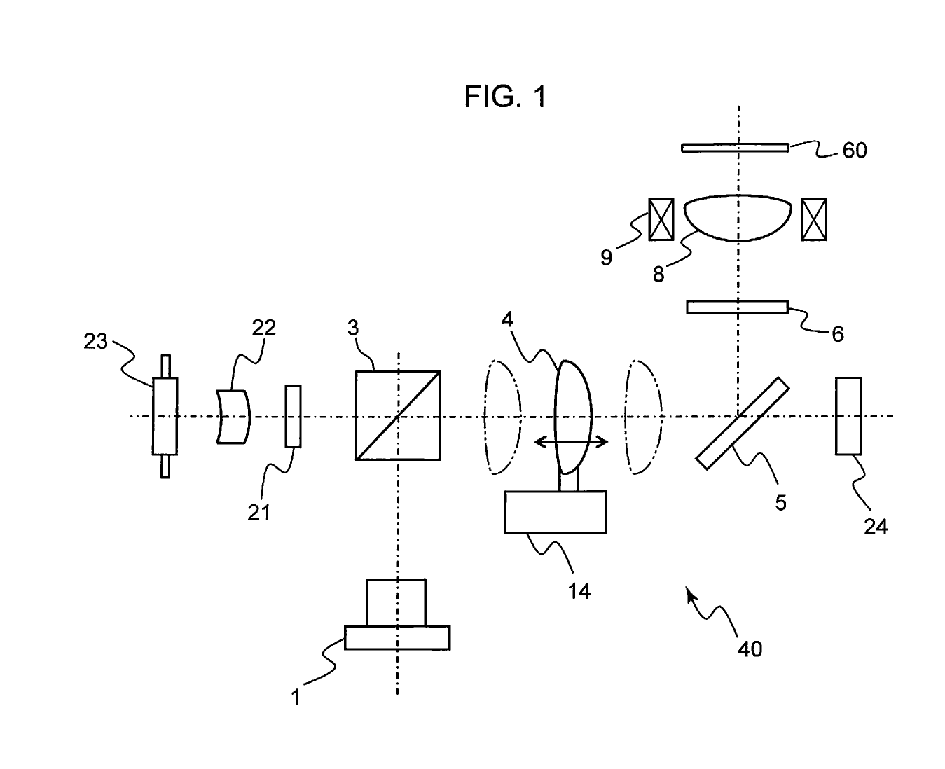

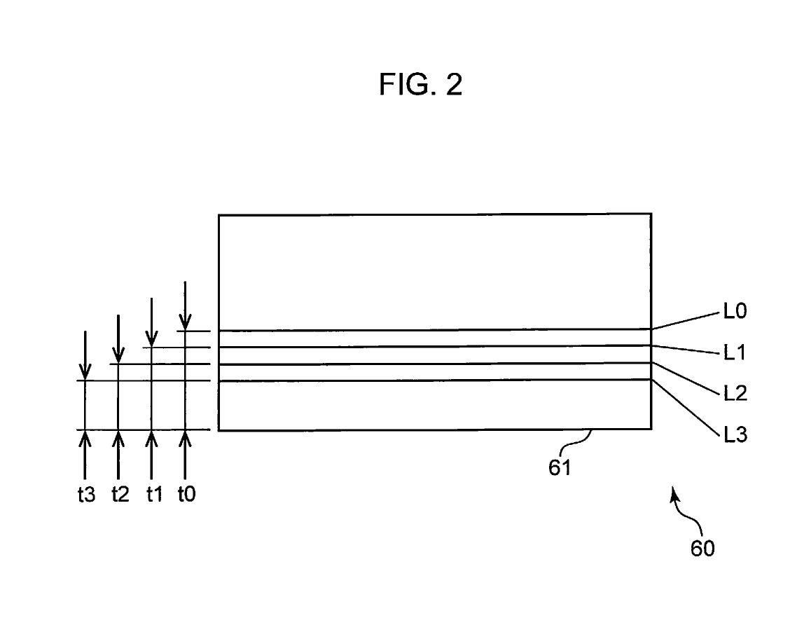

FIG. 1 is a diagram showing the schematic configuration of the optical head in Embodiment 1 of the present invention. FIG. 2 is a diagram showing the schematic configuration of the multi-layer optical disc in Embodiment 1 of the present invention.

In FIG. 1, an optical head 40 comprises a blue-violet laser light source 1, a polarizing beam splitter 3, a collimating lens 4, a standing mirror 5, a quarter wavelength plate 6, an objective lens 8, an objective lens actuator 9, a collimating lens actuator 14, a detection hologram 21, a detection lens 22, a light-receiving element 23 and a front monitor sensor 24.

Moreover, a multi-layer optical disc 60 comprises, as shown in FIG. 2, four information recording surfaces L0 to L3 in which the thickness t0 to t3 of the light transmitting layer is 100 μm to 50 μm. The thickness t0 of the light transmitting layer of the information recording surface L0 is, for example, 100 μm, the thickness t1 of the light transmitting layer of the information recording surface L1 is, for example, 83 μm, the thickness t2 of the light transmitting layer of the information recording surface L2 is, for example, 59 μm, and the thickness t3 of the light transmitting layer of the information recording surface L3 is, for example, 50 μm.

Note that, in the present specification, a light transmitting layer represents the layer from the information recording surface to a surface (light entrance surface) 61 of the multi-layer optical disc 60. Thus, the thickness of the light transmitting layer of the information recording surface represents the distance from the information recording surface to the surface 61 of the multi-layer optical disc 60. An intermediate layer is disposed between the respective information recording surfaces, a cover layer is disposed on the light entrance surface side of the information recording surface that is closest to the surface 61 of the multi-layer optical disc 60, and a substrate is disposed on a side that is opposite to the light entrance surface of the information recording surface that is farthest from the surface 61 of the multi-layer optical disc 60.

The optical head 40 records or reproduces information to or from the multi-layer optical disc (information recording medium) 60 including a plurality of information recording surfaces in which the thickness of the light transmitting layer is respectively different. The blue-violet laser light source 1 emits a blue-violet laser beam having a wavelength of approximately 405 nm. The objective lens 8 has an orbicular zone-shaped diffractive structure, and diffracts the blue-violet laser beam and converges the generated diffracted light of n-th order (where n is a natural number) on a predetermined information recording surface of the multi-layer optical disc 60.

The light-receiving element (photodetector) 23 receives the blue-violet laser beam that was reflected by the predetermined information recording surface. The collimating lens (coupling lens) 4 is disposed between the blue-violet laser light source 1 and the objective lens 8. The collimating lens actuator (spherical aberration correction unit) 14 corrects, by moving the collimating lens 4 in an optical axis direction, the spherical aberration which occurs according to a distance from a light entrance surface of the multi-layer optical disc 60 to the information recording surface.

The operation of the optical head 40 upon recording or reproducing information to or from the multi-layer optical disc 60 is now explained. The blue-violet laser beam having a wavelength of approximately 405 nm emitted from the blue-violet laser light source 1 enters the polarizing beam splitter 3 as S-polarized light. The blue-violet laser beam that was reflected by the polarizing beam splitter 3 is converted into substantially parallel light by the collimating lens 4, and enters the standing mirror 5. A part of the blue-violet laser beam that entered the standing mirror 5 is reflected in the direction of the quarter wavelength plate 6.

The remainder of the laser beam that entered the standing mirror 5 is transmitted through the standing mirror 5 and enters the front monitor sensor 24. In addition, the output of the blue-violet laser light source 1 is controlled based on the output of the front monitor sensor 24. Meanwhile, the blue-violet laser beam that was reflected by the standing mirror 5 is converted into circularly polarized light by the quarter wavelength plate 6, and thereafter converged by the objective lens 8 as an optical spot of one of the information recording surfaces L0 to L3 of the multi-layer optical disc 60.

The blue-violet laser beam that was reflected by the predetermined information recording surface of the multi-layer optical disc 60 is once again transmitted through the objective lens 8, converted into linear polarized light, which is different from the forward path, by the quarter wavelength plate 6, and thereafter reflected by the standing mirror 5. The blue-violet laser beam that was reflected by the standing mirror 5 is transmitted through the collimating lens 4, and thereafter enters the polarizing beam splitter 3 as P-polarized light. The blue-violet laser beam that was transmitted through the polarizing beam splitter 3 is guided to the light-receiving element 23 via the detection hologram 21 and the detection lens 22. The blue-violet laser beam that was detected by the light-receiving element 23 is subject to photoelectric conversion. The signals generated by the photoelectric conversion are computed with a control unit (not shown), and a focus error signal for following a surface fluctuation of the multi-layer optical disc 60, a tracking error signal for following an eccentricity of the multi-layer optical disc 60, and a reproduction signal are generated.

Detection of the focus error signal and detection of the tracking error signal in the optical head of Embodiment 1 are now explained.

The focus error signal for following the surface fluctuation of the multi-layer optical disc 60 is detected by the so-called astigmatic method of the like in which the light-focusing spot given astigmatism by the detection lens 22 is detected as a quartered light-receiving pattern in the light-receiving element 23.

Meanwhile, the tracking error signal for following the eccentricity of the multi-layer optical disc 60 is generated by detecting the 0-th order light and the 1st order diffracted light, which were generated upon being transmitted through the detection hologram 21, in a predetermined light-receiving area of the light-receiving element 23. It is thereby possible to inhibit the fluctuation of the tracking error signal which occurs when there is variation in the position, width and depth of the groove of the information track formed on the multi-layer optical disc 60, and the fluctuation of the tracking error signal which occurs when information is recorded on an information track and the reflectance is changed.

Note that the detection of the focus error signal and the tracking error signal is not limited to the foregoing detection methods and, for example, the tracking error signal can also be generated by using the so-called differential push-pull method (DPP method) or the like which uses a main beam and a sub beam generated by a diffraction grating.

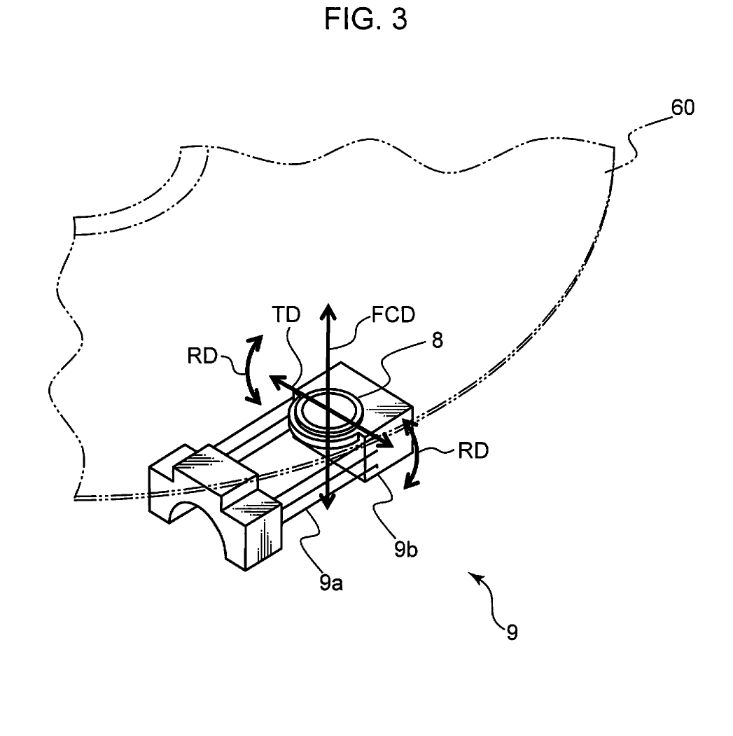

The objective lens actuator in this embodiment is now explained. FIG. 3 is a view showing a frame format of the schematic configuration of the objective lens actuator in Embodiment 1 of the present invention.

As shown in FIG. 3, a plurality of suspension wires 9a are supporting an objective lens holder (movable part) 9b. The objective lens actuator 9 drives the objective lens 8 in a biaxial direction (focus direction FCD and tracking direction TD) based on the focus error signal and the tracking error signal so that the optical spot follows the information track of the rotating multi-layer optical disc 60. Note that the objective lens actuator 9 may also be structured so that it can tilt the objective lens 8 in the radial direction RD of the multi-layer optical disc 60 in addition to the displacement of the focus direction FCD and the tracking direction TD.

The collimating lens actuator in Embodiment 1 is now explained. The collimating lens 4 can move in the optical axis direction of the collimating lens 4 based on the collimating lens actuator 14.

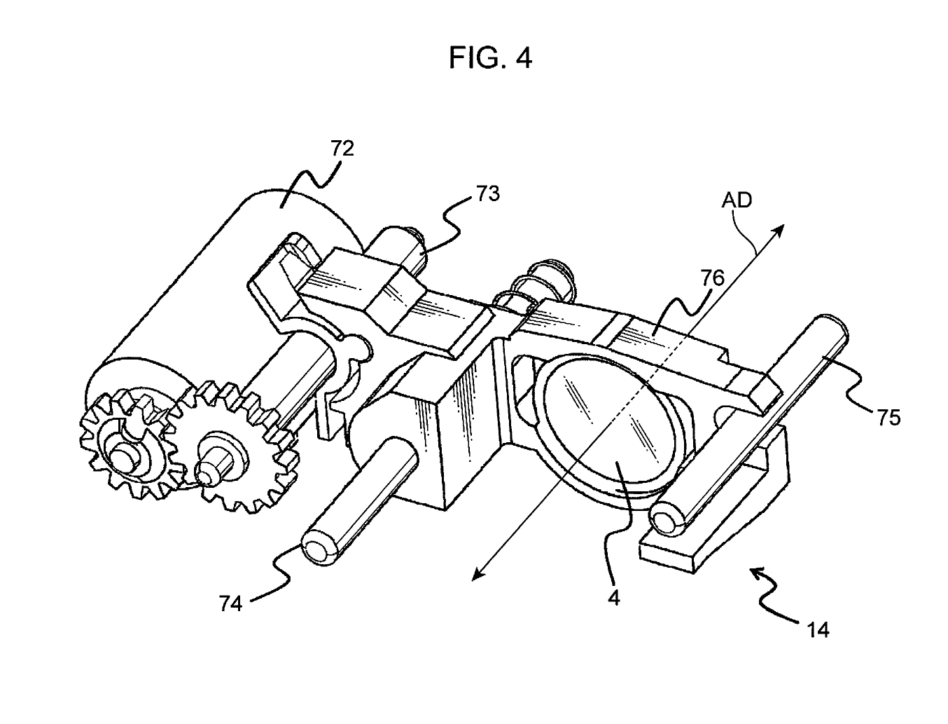

FIG. 4 is a view showing a frame format of the schematic configuration of the collimating lens actuator 14 in Embodiment 1 of the present invention.

In FIG. 4, the collimating lens actuator 14 comprises a stepping motor 72, a screw shaft 73, a primary shaft 74, a secondary shaft 75 and a lens holder 76. As a result of the stepping motor 72 being driven and the screw shaft 73 being rotated, the lens holder 76 holding the collimating lens 4 moves the collimating lens 4 in the optical axis direction AD along the primary shaft 74 and the secondary shaft 75.

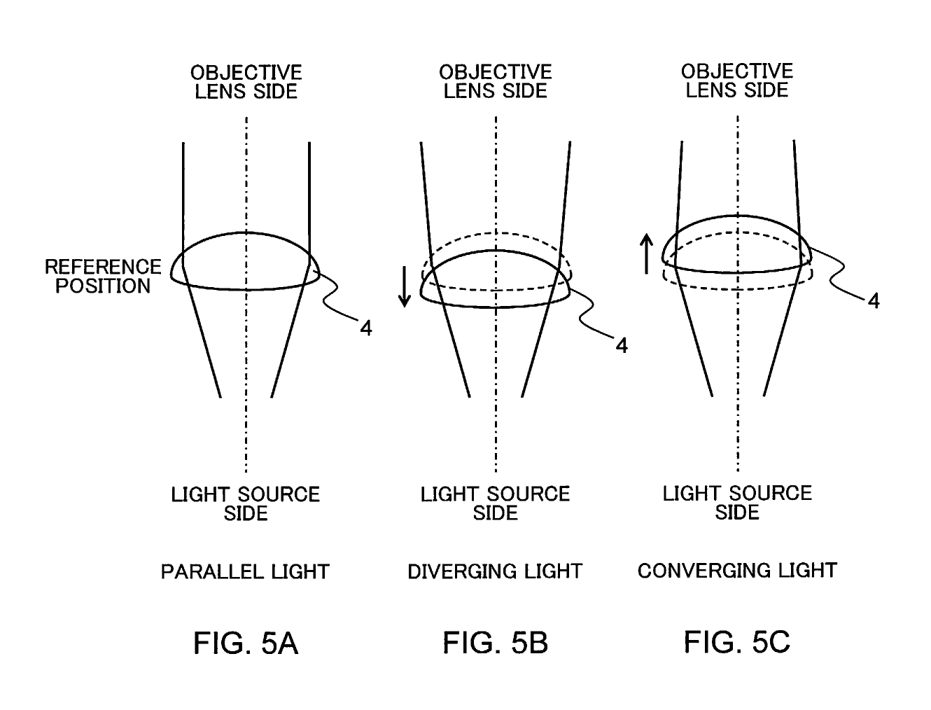

FIG. 5A is a diagram showing the outgoing light when the collimating lens is in the reference position, FIG. 5B is a diagram showing the outgoing light when the collimating lens moves to the light source side, and FIG. 5C is a diagram showing the outgoing light when the collimating lens moves to the objective lens side.

As shown in FIG. 5A, when the collimating lens 4 is in the reference position, the outgoing light of the collimating lens 4 is substantially parallel light. Meanwhile, as shown in FIG. 5B, by moving the collimating lens 4 from the reference position to the light source side, the outgoing light of the collimating lens 4 becomes diverging light, and the spherical aberration which occurs when the light transmitting layer of the multi-layer optical disc 60 becomes thick can be corrected.

Meanwhile, as shown in FIG. 5C, by moving the collimating lens 4 from the reference position to the objective lens side, the outgoing light of the collimating lens 4 becomes converging light, and the spherical aberration which occurs when the light transmitting layer of the multi-layer optical disc 60 becomes thin can be corrected. In other words, in the multi-layer optical disc 60 comprising a plurality of information recording surfaces, the spherical aberration can be corrected by moving the collimating lens 4 according to the thickness of the light transmitting layer of the respective information recording surfaces.

Note that the configuration of the collimating lens actuator 14 of moving the collimating lens 4 in the optical axis direction is not limited to the configuration using the stepping motor 72 as shown in FIG. 4, and, for example, any configuration of an actuator that is driven by a magnetic circuit or a piezoelectric element may also be adopted. With the configuration that uses the stepping motor 72, the system can be simplified since there is no need to monitor the position of the optical axis direction of the collimating lens 4. Meanwhile, since an actuator that is driven by a magnetic circuit or a piezoelectric element has a small drive part, it is suitable for downsizing the optical head.

The objective lens 8 of Embodiment 1 is now explained in detail. The objective lens 8 is designed, for example, as follows. Note that the design light transmitting layer thickness represents the thickness of the light transmitting layer in which the spherical aberration becomes minimal (substantially zero) when parallel light enters the objective lens 8.

Design wavelength: 405 nm

Design temperature: 40° C.

Design light transmitting layer thickness: 75 μm

Focal length: 1.3 mm

Numerical aperture (NA): 0.85

Working distance: 0.3 mm

Refractive index (nd): 1.51

Abbe's number (νd): 57

The objective lens 8 is a single lens made of resin. Thus, the specific gravity is small in comparison to a glass objective lens, and the burden of the objective lens actuator 9 for performing focus servo or tracking servo can be alleviated. Moreover, mass production is enabled with a high degree of accuracy via injection molding, and this is suitable for cost reduction.

The objective lens 8 has a design light transmitting layer thickness of 75 μm. Accordingly, when focusing a blue-violet laser beam on the information recording surface L0 in which the thickness of the light transmitting layer is 100 μM and the information recording surface L1 in which the thickness of the light transmitting layer is 83 μm, diverging light is caused to enter the objective lens 8 by moving the collimating lens 4 to the light source side. It is thereby possible to correct the spherical aberration which occurs as a result of the thickness of the light transmitting layer deviating from the design light transmitting layer thickness. Meanwhile, when focusing a blue-violet laser beam on the information recording surface L2 in which the thickness of the light transmitting layer is 59 μm and the information recording surface L3 in which the thickness of the light transmitting layer is 50 μm, converging light is caused to enter the objective lens 8 by moving the collimating lens 4 to the objective lens side. It is thereby possible to correct the spherical aberration which occurs as a result of the thickness of the light transmitting layer deviating from the design light transmitting layer thickness.

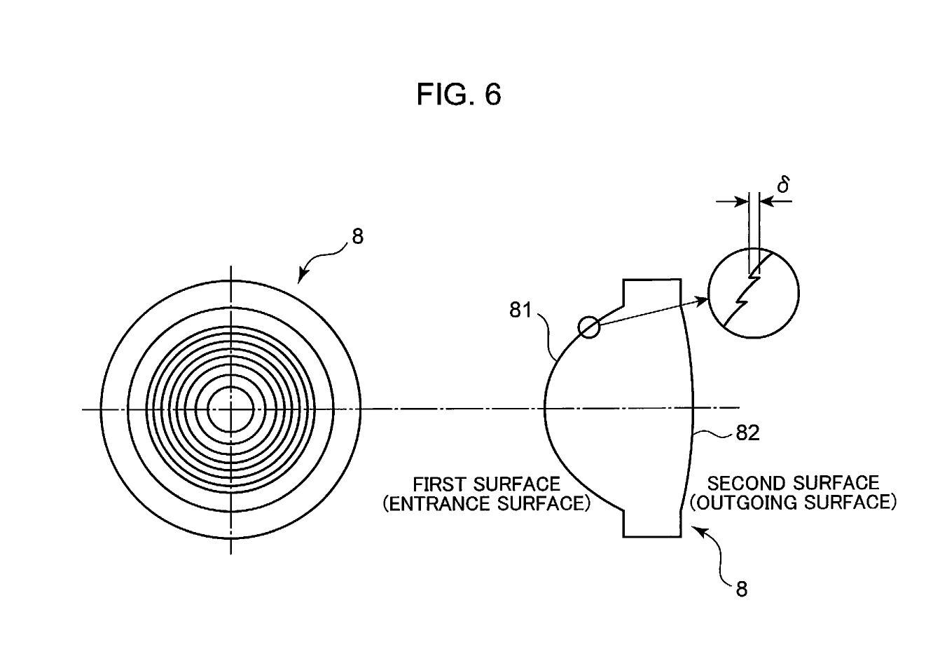

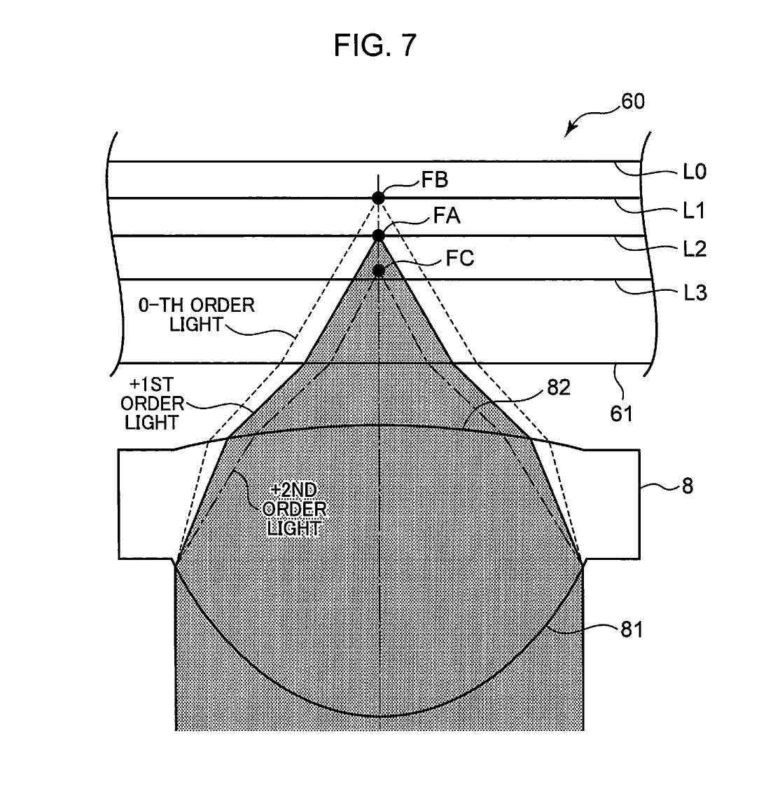

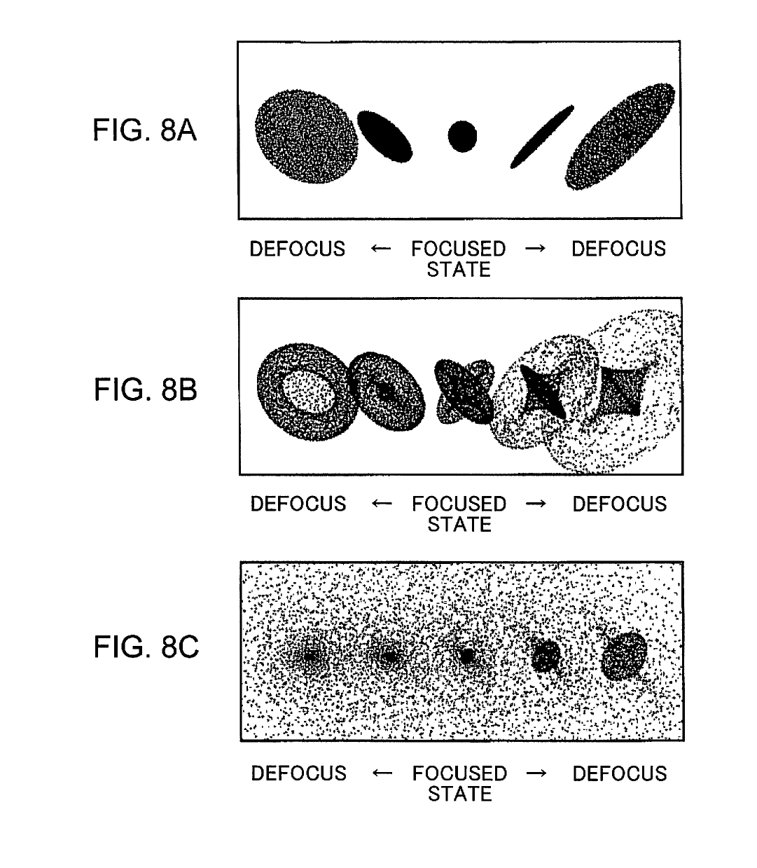

FIG. 6 is a diagram schematically showing the shape of the objective lens in Embodiment 1 of the present invention. The objective lens 8 includes a first surface (entrance surface) 81 to which the blue-violet laser beam enters, and a second surface (outgoing surface) 82 from which the blue-violet laser beam exists.

With the objective lens 8, as shown in FIG. 6, an orbicular zone-shaped diffractive lens structure is formed around the optical axis on the first surface (entrance surface) 81. This diffractive lens structure includes a step δ in the optical axis direction at the boundary of the respective orbicular zones, and is configured so that the diffraction efficiency of the +1st order light (+1st order diffracted light) is maximized in the blue-violet laser beam having a wavelength of 405 nm which was emitted from the blue-violet laser light source 1. However, since the diffraction efficiency of light of a diffractive order other than the +1st order light; for instance, the diffractive order of 0-th order light, −1st order light and ±2nd order light cannot zeroed, these become useless light which is referred to as diffracted stray light. This kind of diffracted stray light is converged at a position that is different from the +1st order light on the optical axis, and form an optical spot.

Based on the diffractive lens structure of the objective lens 8, +1st order light having a (positive) power component of the convex lens is generated. With diffracted light having a power component of the convex lens as described above, the diffraction angle at the diffractive surface increases and the convex power intensifies when the wavelength of the blue-violet laser beam emitted from the blue-violet laser light source 1 shifts to the long-wavelength side. Meanwhile, the diffraction angle at the diffractive surface decreases and the convex power weakens when the wavelength of the blue-violet laser beam emitted from the blue-violet laser light source 1 shifts to the short-wavelength side. These phenomena function to offset the misalignment of the focal point; that is, the defocus which arises due to the change in the refractive index of the objective lens associated with the wavelength change in the object lens 8, and yields the so-called longitudinal chromatic aberration corrective effect.

The longitudinal chromatic aberration characteristics of the objective lens 8 of Embodiment 1 are 0.1 μm/nm. In other words, the amount of defocus relative to a wavelength change of 1 nm is 0.1 μm.

Accordingly, a defocus which occurs due to the wavelength fluctuation of the blue-violet laser beam emitted from the blue-violet laser light source 1 upon switching the recording power and the reproduction power or upon any change in the ambient temperature can be favorably corrected.

For example, when the maximum output of a high-output blue-violet laser light source 1 is 300 mW (pulse), and the wavelength change associated with the output change of the blue-violet laser light source 1 is 0.01 nm/mW, the amount of wavelength change of the blue-violet laser from the blue-violet laser light source 1 associated with the change in emission power during reproduction and during recording will be 300×½×0.01=1.5 [nm]. The tolerable amount of defocus is determined by the wavelength of the blue-violet laser beam emitted from the blue-violet laser light source 1 and the numerical aperture (NA). If the tolerable amount of defocus is, for example, 0.15 μm, then the longitudinal chromatic aberration characteristics will be 0.15/1.5=0.1 μm/nm].

Note that the tolerable amount of defocus can be slightly increased by applying a predetermined electrical offset immediately before switching between reproduction and recording. Accordingly, in most cases, there will be no substantial problem so as long as the longitudinal chromatic aberration characteristics are 0.15 μm/nm or less. Meanwhile, even when giving consideration to the various error factors, the longitudinal chromatic aberration characteristics will be sufficient at 0.05 μm/nm. If the longitudinal chromatic aberration characteristics are less than 0.05 μm/nm, the pitch of the orbicular zone-shaped pattern needs to be reduced in order to further increase the (positive) power component of the convex lens based on the diffractive lens structure, and the diffraction efficiency will drastically deteriorate.

As described above, the longitudinal chromatic aberration characteristics of the optical head 40 for recording information on the multi-layer optical disc 60 are desirably 0.05 μm/nm or more and 0.15 μm/nm or less. In other words, preferably, the objective lens reduces a change in the converged position of the blue-violet laser beam which occurs pursuant to a wavelength change of the blue-violet laser beam emitted from the blue-violet laser light source 1, and a variation D [μm/nm] of the converged position of the laser beam which occurs pursuant to a unit wavelength change in the blue-violet laser beam emitted from the blue-violet laser light source 1 satisfies 0.05 [μm/nm]≦D≦0.15 [μm/nm].

Note that, when considering the objective lens 8 comprising the foregoing diffractive lens structure separately as the diffractive lens, and the underlying refractive lens excluding the diffractive lens, the positive longitudinal chromatic aberration of the underlying refractive lens is corrected by the negative longitudinal chromatic aberration of the diffractive lens.

Here, when deeming the diffractive lens as a virtual refractive lens having a positive power component as well as a negative dispersion value, the objective lens 8 comprising the diffractive lens structure of Embodiment 1 can be considered a cemented lens (complex lens) of the foregoing virtual refractive lens and the underlying refractive lens. In the foregoing case, the relation of the focal length (power distribution) of the two refractive lenses can be uniquely determined based on the conditions of the arbitrary synthesized focal length and the longitudinal chromatic aberration characteristics.

If the longitudinal chromatic aberration characteristics in the objective lens 8 are 0.05 μm/nm, the focal length based on the diffractive lens will be 74 mm and the focal length of the underlying refractive lens will be 1.319 mm, and the ratio of power (reciprocal of focal length) of the diffractive lens and the underlying refractive lens will be approximately 0.02. Moreover, if the longitudinal chromatic aberration characteristics in the objective lens 8 are 0.15 μm/nm, the focal length based on the diffractive lens will be 303 mm and the focal length of the underlying refractive lens will be 1.304 mm, and the ratio of power (reciprocal of focal length) of the diffractive lens and the underlying refractive lens will be 0.004.

In other words, in the objective lens 8 comprising the diffractive lens structure that is used in the optical head 40 for recording information on the multi-layer optical disc 60, when an optical path difference function Φ(h) which represents an addition of the optical path length caused by the diffractive structure is represented as
Φ(h)=P₂×h²+P₄×h⁴+P₆×h⁶+ . . . +P₂ₖ×h^{2k} (where k is a natural number), and a power φ_{D} of the lens caused by the diffractive structure is represented as φ_{D}=−(2×P₂×n×λ),

the power φ_{D} of the lens caused by the diffractive structure, and a power φ_{R} of an underlying refractive lens excluding the diffractive structure in the objective lens 8 desirably satisfy following Formula (1).

0.004≦φ_{D}/φ_{R}≦0.02 (1)

where h represents a height from an optical axis, n represents a diffractive order, P₂, P₄, P₆, . . . , P₂ₖ represent a coefficient, and k represents a wavelength of the laser beam.

Here, with the objective lens 8 of Embodiment 1, a spherical aberration component is additionally superimposed on the power component of the diffracted light. The spherical aberration component added by the diffractive lens structure has spherical aberration characteristics where the spherical aberration changes in a direction of under-correction (under) when a wavelength of the blue-violet laser beam emitted from the blue-violet laser light source 1 shifts to a long-wavelength side.

FIG. 7 is a schematic diagram showing the appearance where a blue-violet laser beam is converged on the information recording surface L2 of the multi-layer optical disc 60 by using the objective lens 8 of Embodiment 1. In FIG. 7, based on the power component and spherical aberration component of the convex lens caused by the diffractive lens structure formed on the first surface (entrance surface) 81 of the objective lens 8 and the power component and spherical aberration component caused by the shape of the first surface 81 and the second surface 82 of the objective lens 8, +1st order light is converging in a substantially aplanatic state on the information recording surface L2. This +1st order light is referred to as the “+1st order light of a forward path”. The +1st order light of a forward path is reflected by the information recording surface L2, thereafter additionally diffracted by the diffractive lens structure formed on the first surface 81 of the objective lens 8, and generates +1st order light. This +1st order light is referred to as the “+1st order light of a return path”. This +1st order light of a return path is focused on the light-receiving element 23 and becomes signal light.

Meanwhile, as shown in FIG. 7, when recording or reproducing information to or from a predetermined information recording surface (for instance, the information recording surface L2) of the multi-layer optical disc 60 by using the +1st order light, there are cases where the diffracted light (diffracted stray light) of another order focuses on an information recording surface that is different from the information recording surface to be subject to recording or reproduction, or on the surface 61 of the multi-layer optical disc 60.

For example, the objective lens 8 adds a power component of the convex lens to the +1st order light based on the diffractive lens structure. Here, since the 0-th order light has small convex lens power, the position FB where the 0-th order light converges becomes farther than the position FA where the +1st order light converges when viewed from the objective lens 8. Meanwhile, since the +2nd order light has large convex lens power, the position FC where the +2nd order light converges becomes closer than the position FA where the +1st order light converges when viewed from the objective lens 8. Note that the power component of the convex lens that is added by the diffractive lens structure of the objective lens 8 is uniquely determined based on the longitudinal chromatic aberration performance of the objective lens 8. Thus, the spacing of the position where the +1st order light converges and the position where the 0-th order light and the +2nd order light converge is uniquely determined.

Accordingly, for example, as shown in FIG. 7, there are cases where the 0-th order light converges near the information recording surface L1 that is more on the far side than the information recording surface L2 when viewed from the surface 61 of the disc, and the +2nd order light converges near the information recording surface L3 that is more on the near side than the information recording surface L2 when viewed from the surface 61 of the disc.

Here, the 0-th order light (0-th order light of a forward path) that converged near the information recording surface L1 is reflected by the information recording surface L1, and thereafter enters the objective lens 8. The first surface 81 of the objective lens 8 generates the 0-th order light of a return path, and the generated 0-th order light of a return path is focused on the light-receiving element 23. Similarly, the +2nd order light (+2nd order light of a forward path) that converged near the information recording surface L3 is reflected by the information recording surface L3, and thereafter enters the objective lens 8. The first surface 81 of the objective lens 8 generates the +2nd order light of a return path, and the generated +2nd order light of a return path is focused on the light-receiving element 23.

As described above, the diffracted stray light that was reflected by an information recording surface that is different from the information recording surface to be subject to recording or reproduction (or the surface of the multi-layer optical disc) is focused on the light-receiving element 23, interferes with the signal light and deteriorates the information signal or causes an offset in the servo signal (focus error signal or tracking error signal).

Nevertheless, with the objective lens 8 of Embodiment 1, a spherical aberration component is additionally superimposed on the power component of the diffracted light. Thus, a spherical aberration component remains in the 0-th order light of a return path and the +2nd order light of a return path (diffracted stray light) that are focused on the light-receiving element 23.

FIG. 8A to FIG. 8C are diagrams showing the appearance of light-focusing spots on the light-receiving element in Embodiment 1 of the present invention. The light-focusing spot is given astigmatism in a direction of 45 degrees by the detection lens 22, and this will expand due to defocusing.

FIG. 8A is a diagram showing the light-focusing spot (signal light) that was formed as a result of the +1st order light of a forward path being reflected by the information recording surface L2 and the +1st order light of a return path being focused on the light-receiving element.

FIG. 8B is a diagram showing the light-focusing spot (diffracted stray light) that was formed as a result of the 0-th order light of a forward path being reflected by the information recording surface L1 and the 0-th order light of a return path being focused on the light-receiving element in a conventional objective lens in which a spherical aberration component is not superimposed on the diffracted light; that is, which only has a power component. FIG. 8C is a diagram showing the light-focusing spot (diffracted stray light) that was formed as a result of the 0-th order light of a forward path being reflected by the information recording surface L1 and the 0-th order light of a return path being focused on the light-receiving element in the objective lens 8 of Embodiment 1.

As shown in FIG. 8B, with the diffracted stray light in the case of using a conventional objective lens, a light-focusing spot having roughly the same size as the signal light (FIG. 8A) is formed depending on the defocusing state. Thus, the quality of the information signal or servo signal will deteriorate due to the interference of the diffracted stray light and the signal light.

Meanwhile, as shown in FIG. 8C, the diffracted stray light of the objective lens 8 of Embodiment 1 is not focused on one point regardless of the defocusing state due to the spherical aberration component. Thus, it is possible to considerably reduce the interference of the diffracted stray light and the signal light (FIG. 8A), and improve the quality of the information signal or the servo signal.

Note that, even in cases where diffracted light other than the +1st order light is not converged on an information recording surface that is different from the information recording surface to be subject to recording or reproduction or on the surface of the multi-layer optical disc, there are cases where a light-focusing spot is formed on the light-receiving element 23 via a different diffractive order before and after the reflection by the information recording surface; that is, via a different diffractive order in the forward path and the return path.

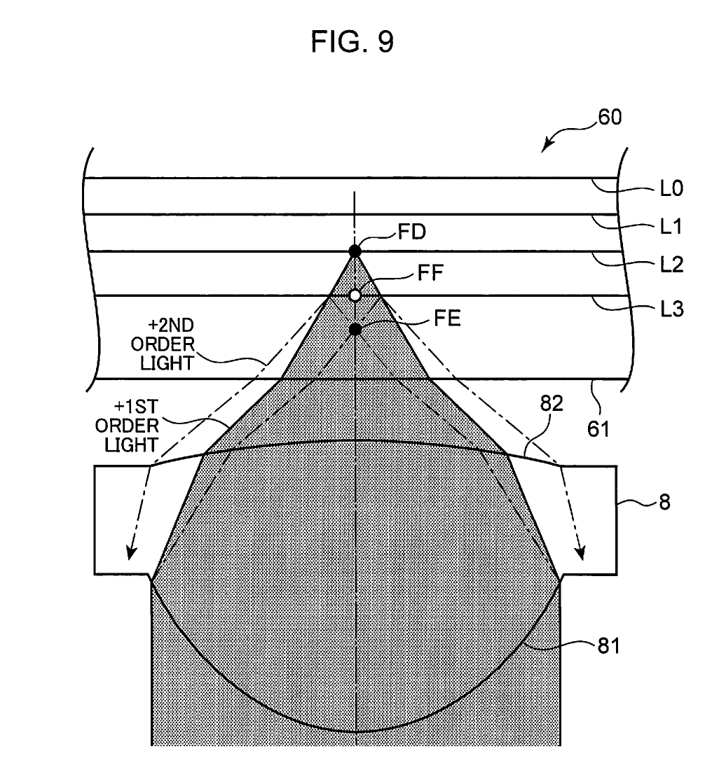

FIG. 9 is a schematic diagram showing the appearance where the +1st order light and the +2nd order light are converged on the multi-layer optical disc, when the light-focusing spot is formed on the light-receiving element without the +2nd order light being converged on the information recording surface, in Embodiment 1 of the present invention.

As shown in FIG. 9, for instance, even when the +2nd order light converges more on the surface 61 side of the disc than the information recording surface L3 and does not converge on any one of the information recording surfaces, after the +2nd order light of a forward path is reflected by the information recording surface L3, the +1st order light of a return path is generated on the first surface 81 of the objective lens 8. In the foregoing case, as shown in FIG. 9, it is possible to deem that a virtual converged position FF exists between the position FD where the +1st order light converges and the position FE where the +2nd order light converges.

When this virtual converged position FF coincides with another information recording surface (for instance, the information recording surface L3) or the surface 61 of the multi-layer optical disc, in a conventional objective lens, the diffracted stray light focused on the light-receiving element 23 based on the +2nd order light of a forward path and the +1st order light of a return path (or the +1st order light of a forward path and the +2nd order light of a return path) forms a light-focusing spot having roughly the same size as the signal light (+1st order light of a forward path and +1st order light of a return path). Accordingly, the quality of the information signal or the servo signal will deteriorate due to interference.

Nevertheless, even in the foregoing case, since the diffracted stray light of the objective lens 8 of Embodiment 1 is not focused on one point due to the spherical aberration component, it is clearly possible to reduce the interference with the signal light as described above.

As described above, a multi-layer optical disc has numerous information recording surfaces and the spacing of the information recording surfaces is also small. Thus, it is extremely difficult to define the power component of the diffractive lens so that all diffracted stray lights that were reflected by the respective information recording surfaces will not be focused on the light-receiving element, and simultaneously pursue the power component and longitudinal chromatic aberration performance.

Accordingly, the optical head 40 of Embodiment 1 which considerably reduced the interference of the signal light and the diffracted stray light as a result of additionally superimposing a spherical aberration component on the power component of the diffracted light is extremely suitable for the recording or reproduction of information to or from the multi-layer optical disc 60.

Meanwhile, while a case was explained where, in the objective lens 8 of Embodiment 1, the spherical aberration component added by the diffractive lens structure has spherical aberration characteristics where the spherical aberration changes in a direction of under-correction (under) when a wavelength of the blue-violet laser beam emitted from the blue-violet laser light source 1 shifts to a long-wavelength side, the present invention is not limited to the foregoing spherical aberration characteristics. For example, the spherical aberration component added by the diffractive lens structure may also have spherical aberration characteristics where the spherical aberration changes in a direction of over-correction (over) when a wavelength of the blue-violet laser beam emitted from the blue-violet laser light source 1 shifts to a long-wavelength side. In the foregoing case also, it is evident that the interference of the signal light and the diffracted stray light can be reduced considerably.

Nevertheless, as with the objective lens 8 of Embodiment 1, since the spherical aberration component added by the diffractive lens structure has spherical aberration characteristics where the spherical aberration changes in a direction of under-correction (under) when a wavelength of the blue-violet laser beam emitted from the blue-violet laser light source 1 shifts to a long-wavelength side, the change in the spherical aberration of the plastic refractive lens that will be over-corrected (over) due to a rise in temperature can be negated with the change in the spherical aberration which occurs pursuant to the wavelength shift of the blue-violet laser light source 1 due to a rise in temperature.

The correction of the spherical aberration which occurs pursuant to this temperature change is now explained in detail.

In a refractive lens that does not have a diffractive lens structure, the spherical aberration which occurs pursuant to a temperature change can be represented as the sum (α+β) [mλ/° C.] of the spherical aberration a [mλ/° C.] which becomes over-corrected (over) as a result of the change in the refractive index of the glass material when the wavelength of the laser beam emitted from the light source shifts to the long-wavelength side due to the rise in temperature, and the spherical aberration β[mλ/° C.] which becomes over-corrected (over) as a result of the change in the refractive index of the glass material due to the rise in temperature.

For example, in a refractive lens that does not have a diffractive lens structure of the same specification as the objective lens 8 of Embodiment 1, when the amount of wavelength shift during a temperature change is 0.06 [nm/° C.], the spherical aberration α, the spherical aberration β and the sum (α+β) will be as follows.

α=+0.3 [mλ/° C.]

β=+3.9 [mλ/° C.]

α+β=+4.2 [mλ/° C.]

Meanwhile, the objective lens 8 of Embodiment 1 has spherical aberration characteristics where the spherical aberration changes in a direction of under-correction (under) when a wavelength of the laser beam emitted from the light source shifts to a long-wavelength side due to a rise in temperature in a diffractive lens structure. The foregoing amount of spherical aberration γ is γ=−0.3 [mλ/° C.], and satisfies γ=−α(α=−γ).

In other words, the objective lens 8 of Embodiment 1 is designed so that spherical aberration does not occur relative to a wavelength change. The spherical aberration component added by the diffractive structure satisfies following Formula (2).

α≅−γ (2)

where α represents the spherical aberration which occurs due to a change in the diffraction angle caused by the diffractive structure pursuant to a unit wavelength change in the laser beam emitted from the light source, and γ represents the spherical aberration which occurs due to a change in the refractive index of the objective lens pursuant to a unit wavelength change in the laser beam emitted from the light source.

Note that, when spherical aberration does not occur relative to a wavelength change, there is no need to strictly achieve γ=−α(α=−γ), and, substantially, it will suffice if the spherical aberration component added by the diffractive structure satisfies following Formula (3).

0.8×|α|≦|γ|≦1.2×|α| (3)

where α represents the spherical aberration which occurs due to a change in the diffraction angle caused by the diffractive structure pursuant to a unit wavelength change in the laser beam emitted from the light source, γ represents the spherical aberration which occurs due to a change in the refractive index of the objective lens pursuant to a unit wavelength change in the laser beam emitted from the light source, and α and γ have polarities opposite to each other.

Here, when an objective lens 8 made of resin is used in the optical head 40, the range of movement of the collimating lens 4 must be ensured so that the following first to fifth spherical aberrations can be corrected.

In other words, the optical head 40 corrects a first spherical aberration which occurs as a result of the light transmitting layer thickness of the information recording surface deviating from the design light transmitting layer thickness, a second spherical aberration remaining in the objective lens or other optical elements, a third spherical aberration which occurs when the wavelength of the laser beam emitted from the light source is shifted due to a temperature change, a fourth spherical aberration which occurs due to a change in the refractive index of the glass material caused by a temperature change, and a fifth spherical aberration which occurs due to the individual variability of the light source wavelength.

The first spherical aberration is uniquely determined in proportion to the standard of the multi-layer optical disc 60; that is, the difference (50 μm) in the light transmitting layer thickness between the information recording surface L0 in which the thickness of the light transmitting layer is largest and the information recording surface L3 in which the thickness of the light transmitting layer is smallest, and the thickness variation (for example, ±5 μm) of the light transmitting layer of the respective information recording surfaces. The second spherical aberration is determined by the aberration standard of the optical element (for instance, 0±20 mλ in the case of an objective lens) used in the optical head 40.

The third spherical aberration and the fourth spherical aberration are determined by the temperature compensation range to be considered in the optical head 40, and the amount of wavelength shift of the blue-violet laser light source 1 during a temperature change.

For example, the operating temperature limit of the objective lens 8 is 10° C. to 70° C. relative to the design temperature of 40° C.; that is, ±30° C. Moreover, the wavelength change of the blue-violet laser light source 1 caused by a temperature change is 0.06 nm/° C., and the wavelength change corresponding to the operating temperature limit of ±30° C. is 1.8 nm.

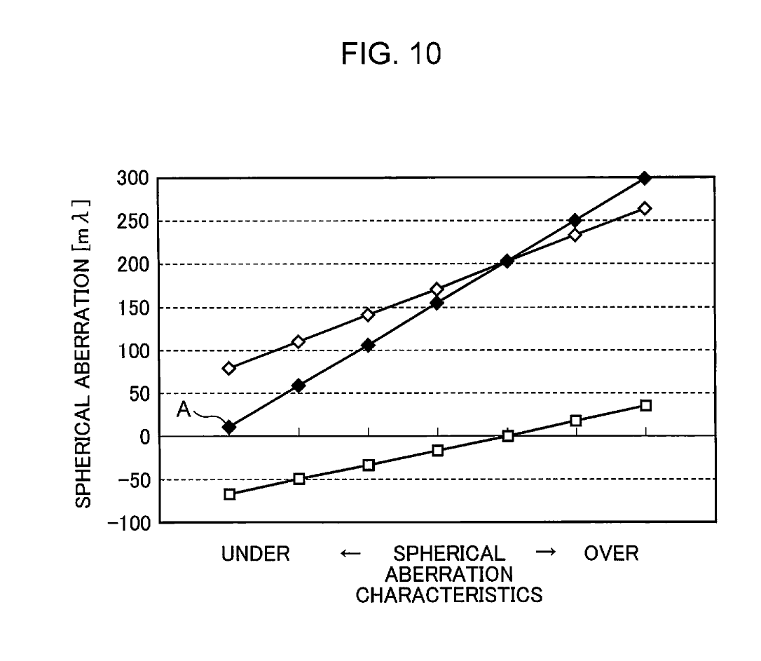

FIG. 10 is a diagram showing the relation between the spherical aberration characteristics based on the diffractive lens structure, and the third spherical aberration and the fourth spherical aberration which occur due to the temperature change in Embodiment 1 of the present invention. Note that FIG. 10 shows the third spherical aberration and the fourth spherical aberration which occur due to a temperature change of up to ±30° C. in the foregoing conditions. Moreover, in FIG. 10, the vertical axis shows the spherical aberration [mλ], and the horizontal axis shows the spherical aberration characteristics. Moreover, the white squares show the third spherical aberration, the white diamonds show the fourth spherical aberration, and the black diamonds show the sum (temperature spherical aberration) of the third spherical aberration and the fourth spherical aberration.

As shown in FIG. 10, as the spherical aberration becomes more under-corrected (under) when the wavelength of the incident light shifts to the long-wavelength side (as the spherical aberration moves leftward in FIG. 10), the third spherical aberration and the fourth spherical aberration will decrease. Consequently, the spherical aberration (temperature spherical aberration) as the sum of the third spherical aberration and the fourth spherical aberration which occurs due to a temperature change all decreases, and the temperature spherical aberration becomes substantially zero at point A in FIG. 10. In other words, spherical aberration will not occur due to a temperature change.

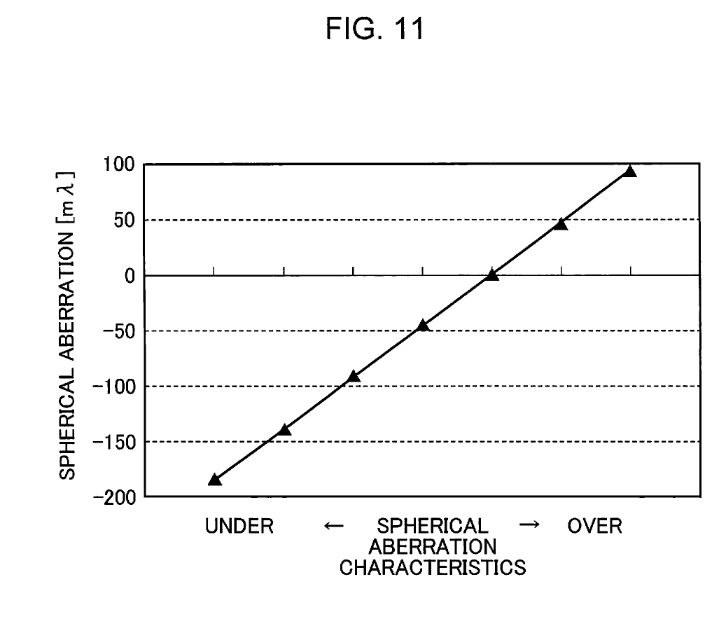

FIG. 11 is a diagram showing the relation between the spherical aberration characteristics based on the diffractive lens structure, and the fifth spherical aberration which occurs due to the individual variability of the light source wavelength in Embodiment 1 of the present invention. The individual variability of the light source wavelength relative to the design wavelength of 405 nm is, for example, ±5 nm, and FIG. 11 shows the fifth spherical aberration which occurs when the light source wavelength changes up to 400 nm to 410 nm. Moreover, in FIG. 11, the vertical axis shows the spherical aberration [mλ], and the horizontal axis shows the spherical aberration characteristics. Moreover, the black triangles show the fifth spherical aberration.

As shown in FIG. 11, as the spherical aberration becomes more under-corrected (under) when the wavelength of the incident light shifts to the long-wavelength side (as the spherical aberration moves leftward in FIG. 11), the fifth spherical aberration will decrease. The value of the fifth spherical aberration also changes as a result of the spherical aberration characteristics based on the diffractive lens structure.

Here, the amount of spherical aberration to be corrected for determining the range of movement of the collimating lens 4 is determined based on the sum of the absolute value of the spherical aberration of FIG. 10; that is, the temperature spherical aberration (third spherical aberration+fourth spherical aberration), and the fifth spherical aberration of FIG. 11 which occurs due to the individual variability of the light source wavelength.

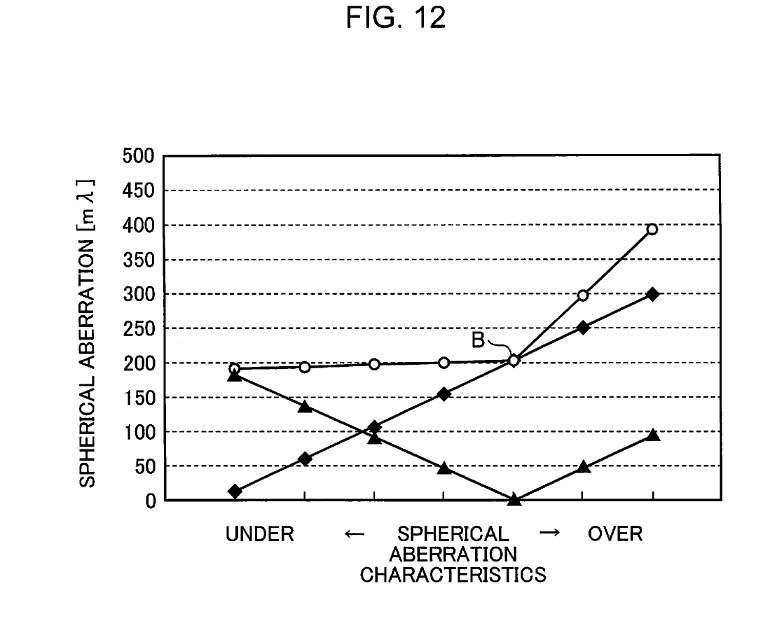

FIG. 12 is a diagram showing the relation between the spherical aberration characteristics based on the diffractive lens structure, and the amount of spherical aberration (total spherical aberration) to be corrected which occurs due to the temperature change and the individual variability of the light source wavelength in Embodiment 1 of the present invention. Note that FIG. 12 shows the third spherical aberration and the fourth spherical aberration which occur due to a temperature change of up to ±30° C., and the fifth spherical aberration which occurs due to the individual variability of the light source wavelength of up to ±5 nm. Moreover, in FIG. 12, the vertical axis shows the spherical aberration [mλ], and the horizontal axis shows the spherical aberration characteristics. Moreover, the black triangles show the fifth spherical aberration, the black diamonds show the sum (temperature spherical aberration) of the third spherical aberration and the fourth spherical aberration, and the white circles show the sum (total spherical aberration) of the third spherical aberration and the fourth spherical aberration and the fifth spherical aberration.

As shown in FIG. 12, as the spherical aberration becomes more under-corrected (under) when the wavelength of the incident light shifts to the long-wavelength side (as the spherical aberration moves leftward in FIG. 12), the total spherical aberration will decrease, but basically stops decreasing from point B in FIG. 12 as the boundary. As evident from FIG. 12, this is a result of the temperature spherical aberration (third spherical aberration +fourth spherical aberration) and the absolute value of the fifth spherical aberration which occurs due to the individual variability of the light source wavelength being set off.

Accordingly, even if the spherical aberration characteristics when the wavelength of the incident light shifts to the long-wavelength side is under-corrected (under) beyond point B of FIG. 12, the total spherical aberration to be corrected; that is, the range of movement of the collimating lens 4 will not decrease.

The objective lens 8 of Embodiment 1 adds a power component of the convex lens to the +1st order light based on the diffractive lens structure as described above. Thus, when spherical aberration characteristics when the wavelength of the incident light shifts to the long-wavelength side is further under-corrected (under), the pitch of the orbicular zone-shaped pattern becomes more narrow. Consequently, problems will arise in that the processing difficulty of the mold increases, the transcription of injection molding deteriorates, and the diffraction efficiency deteriorates due to the narrowing of the pitch.

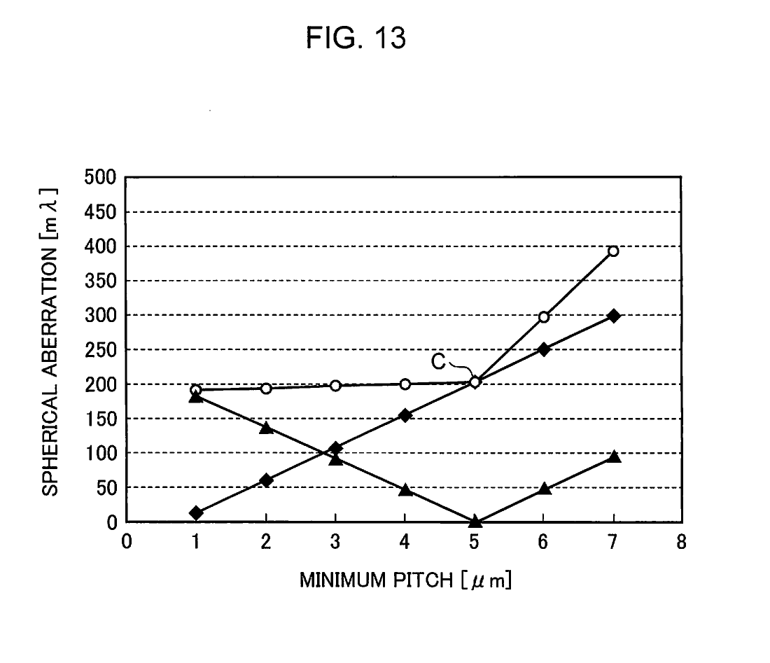

FIG. 13 is a diagram showing the relation between the minimum pitch of the orbicular zone pattern of the diffractive lens structure, and the amount of spherical aberration (total spherical aberration) to be corrected which occurs due to the temperature change and the individual variability of the light source wavelength when the longitudinal chromatic aberration characteristics are set to 0.1 μm/nm in Embodiment 1 of the present invention. Note that FIG. 13 shows the third spherical aberration and the fourth spherical aberration which occur due to a temperature change of up to ±30° C., and the fifth spherical aberration which occurs due to the individual variability of the light source wavelength of up to ±5 nm. Moreover, in FIG. 13, the vertical axis shows the spherical aberration [mλ], and the horizontal axis shows the minimum pitch [μm] of the diffractive lens structure. Moreover, the black triangles show the fifth spherical aberration, the black diamonds show the sum (temperature spherical aberration) of the third spherical aberration and the fourth spherical aberration, and the white circles show the sum (total spherical aberration) of the third spherical aberration and the fourth spherical aberration and the fifth spherical aberration.

As shown in FIG. 13, even if the minimum pitch of the orbicular zone pattern is made to be smaller than 5 μm, it is evident that the total spherical aberration hardly decreases.

The objective lens 8 of Embodiment 1 is designed so that spherical aberration does not occur relative to a wavelength change. In other words, the objective lens 8 of Embodiment 1 comprises the spherical aberration characteristics of point C in FIG. 13. Here, the amount of spherical aberration to be corrected (total spherical aberration) which occurs due to a temperature change of up to ±30° C. and the individual variability of the light source wavelength of up to ±5 nm becomes substantially a minimum value, and the minimum pitch of the orbicular zone pattern of the diffractive lens structure is also 5 μm. Accordingly, it is possible to inhibit the deterioration in the transcription of injection molding and the deterioration caused by the narrowing of the pitch.

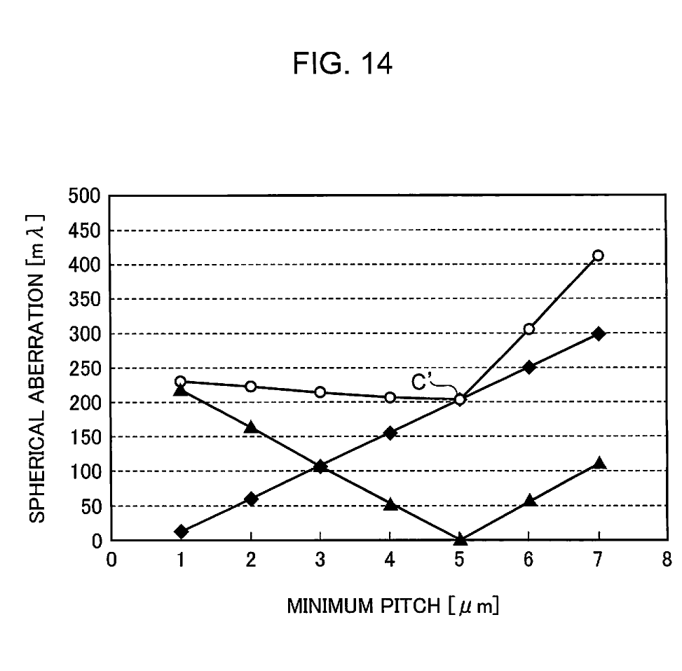

FIG. 14 is a diagram showing the relation between the minimum pitch of the orbicular zone pattern of the diffractive lens structure and the total spherical aberration when the tolerable range of the individual variability of the light source wavelength is expanded in comparison to FIG. 13. Note that, in FIG. 14, the tolerable range of the individual variability of the light source wavelength is expanded up to ±7 nm (that is, 398 nm to 412 nm). FIG. 14 shows the third spherical aberration and the fourth spherical aberration which occur due to a temperature change of up to ±30° C., and the fifth spherical aberration which occurs due to the individual variability of the light source wavelength of up to ±7 nm. Moreover, in FIG. 14, the vertical axis shows the spherical aberration [mλ], and the horizontal axis shows the minimum pitch [μm] of the diffractive lens structure. Moreover, the black triangles show the fifth spherical aberration, the black diamonds show the sum (temperature spherical aberration) of the third spherical aberration and the fourth spherical aberration, and the white circles show the sum (total spherical aberration) of the third spherical aberration and the fourth spherical aberration and the fifth spherical aberration.

In FIG. 14, the total spherical aberration at point C′ where the minimum pitch is 5 μm is equal to the total spherical aberration at point C in FIG. 13. This shows that, even if the tolerable range of the individual variability of the light source wavelength is expanded; that is, even if the tolerable range is expanded from ±5 μm to ±7 μm, it is not necessary to expand the range of movement of the collimating lens 4, and further shows that further cost reduction is possible based on the alleviation of the wavelength standard of the blue-violet laser light source 1.

Note that, with an optical head for use in a multi-layer optical disk in which the amount of spherical aberration which occurs in proportion to the shift length from the optimal light transmitting layer thickness of the objective lens is extremely large pursuant to the expansion of the spacing of the information recording surfaces, it is possible to inhibit the range of movement of the collimating lens 4, and the objective lens 8 of Embodiment 1 which can realize a compact optical head 40 is extremely suitable therefor.

Note that, with the optical head 40 using the objective lens 8 of Embodiment 1, a predetermined amount of spherical aberration occurs pursuant to a temperature change. Thus, preferably, the spherical aberration which occurs pursuant to a temperature change is corrected by detecting the temperature change within the optical head 40 by using a temperature sensor or the like, and moving the collimating lens 4 so as to maximize the amplitude of the information signal or the servo signal, or minimize the predetermined index value (jitter or the like) in the information signal.

Accordingly, with Embodiment 1, a spherical aberration component is additionally superimposed on the diffracted light so as to achieve spherical aberration characteristics in which spherical aberration will not occur relative to a wavelength change in the optical head 40 comprising a longitudinal chromatic aberration correction effect in which a power component of a convex lens is added to the diffracted light based on the diffractive lens structure. It is thereby possible to inhibit the range of movement of the collimating lens 4 and realize a compact configuration while considerably reducing the interference of the signal light and the diffracted stray light.

Nevertheless, even in an optical head that does not require a longitudinal chromatic aberration correction effect (for instance, a reproducing-only optical head), it is evident that it is possible to inhibit the range of movement of the collimating lens and realize a compact configuration by adding a spherical aberration component to the diffracted light so as to achieve spherical aberration characteristics in which spherical aberration will not arise relative to a wavelength change. Accordingly, the optical head of Embodiment 1 is suitable as an optical head for use in a multi-layer optical disk in which the amount of spherical aberration which occurs in proportion to the shift length from the optimal light transmitting layer thickness of the objective lens is extremely large pursuant to the expansion of the spacing of the information recording surfaces.

Note that, although Embodiment 1 explained an optical head for recording or reproducing information to or from a multi-layer optical disc, the present invention is not limited to such an optical head. For example, in addition to a multi-layer optical disc, it is obvious that the present invention can also be applied to a compatible optical head for recording or reproducing information to or from at least one among BDs, DVDs and CDs.

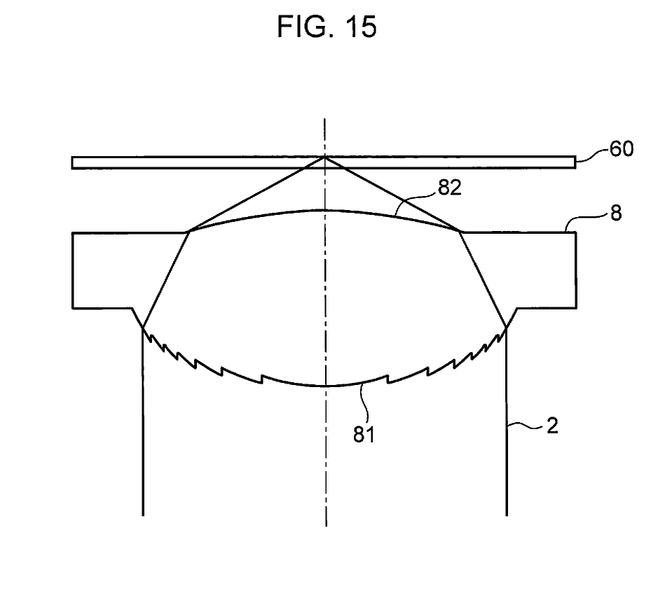

A specific example of the objective lens in Embodiment 1 of the present invention is now explained. FIG. 15 is a diagram explaining a specific example of the objective lens in Embodiment 1 of the present invention.

The objective lens 8 is made from a resin material, and configured from a first surface 81 made from a diffractive surface, and a second surface 82 made from an aspheric surface. Here, the diffractive surface is divided into a plurality of orbicular zone areas in a radial direction from the optical axis, and includes steps that are parallel to the optical axis between the mutually adjacent areas. These steps are of a depth that yields a phase difference of an integral multiple of the wavelength of the laser beam in the refractive index of the material corresponding to the design wavelength and the design temperature.

Moreover, the orbicular zone width (distance between a certain step and a step that is closest to that step in the radial direction) is configured to become monotonically narrow from the optical axis to the periphery of the lens.

The diffractive surface has a convex power and a function of correcting the defocus and 3rd order spherical aberration which occur when the wavelength of the laser beam changes. A luminous flux 2 transmitted through the diffractive surface is transmitted through the aspheric surface of the second surface 82 and is favorably focused on the information recording surface of the multi-layer optical disc 60.

The objective lens 8 of Embodiment 1 is designed so that the amount of 3rd order spherical aberration which occurs on the diffractive surface during a wavelength change and the amount of 3rd order spherical aberration which occurs on a base lens other than on the diffractive surface are basically the same amount, and the two 3rd order spherical aberrations will occur in mutually opposite directions. Thus, 3rd order spherical aberration will hardly occur relative to a wavelength change in the overall lens. Here, a base lens refers to a lens configured only from an aspheric surface that remains after removing the diffractive structure from the surface where the diffractive structure is disposed in a certain diffractive lens.

An objective lens including a diffractive structure shown with three types of numerical Examples is now explained. With the three types of Examples, the longitudinal chromatic aberration is kept low in all cases, but there is difference in the direction and amount of spherical aberration which occurs due to a unit wavelength change, and consequently there is difference in the amount of 3rd order spherical aberration which occurs during a temperature change.

Foremost, the objective lens of Example 1 is shown in Table 2 to Table 6 below. Table 2 is a table showing the specification of the objective lens in Example 1, Table 3 is a table showing the surface shape of the objective lens and the multi-layer optical disc in Example 1, Table 4 is a table showing the refractive index of the objective lens and the light transmitting layer relative to the wavelength and temperature in Example 1, Table 5 is a table showing the aspheric surface coefficient and the phase function of the first surface of the objective lens in Example 1, and Table 6 is a table showing the aspheric surface coefficient and the phase function of the second surface of the objective lens in Example 1.

TABLE 2

| | |
|---|---|
| WAVELENGTH (μm) | 0.405 |
| APERTURE (DIAMETER) (mm) | φ2.236 |
| NA | 0.86 |
| FOCAL DISTANCE (mm) | 1.30 |
| AXIAL CHROMATIC ABERRATION (μm/nm) | 0.10 |
| MINIMUM PITCH (μm) | 10.00 |
| DESIGN TEMPERATURE (° C.) | 40.00 |

TABLE 3

| | APEX | | | |
|---|---|---|---|---|
| | CURVA- | | | |
| SUR- | TURE | THICK- | | |
| FACE | RADIUS | NESS | | SURFACE |
| No. | (mm) | (mm) | MATERIAL | SHAPE |
| 0 | | ∞ | | |
| 1 | 0.9528088 | 1.784846 | | DIFFRACTIVE |
| | | | | SURFACE |
| 2 | −0.956977 | 0.3 | OBJECTIVE | ASPHERIC |
| | | | LENS GLASS | SURFACE |
| | | | MATERIAL | |
| 3 | ∞ | 0.0875 | LIGHT | FLAT |
| | | | TRANSMITTING | SURFACE |
| | | | LAYER | |
| 4 | ∞ | | | FLAT |
| | | | | SURFACE |

TABLE 4

| | | | | | | | |
|---|---|---|---|---|---|---|---|
| WAVELENGTH (μm) | 0.405 | 0.405 | 0.405 | 0.403 | 0.407 | 0.403 | 0.407 |
| TEMPERATURE (° C.) | 10 | 40 | 80 | 40 | 40 | 0 | 80 |
| OBJECTIVE LENS | 1.52604 | 1.52228 | 1.51838 | 1.52258 | 1.52198 | 1.52634 | 1.52574 |
| GLASS MATERIAL | | | | | | | |
| LIGHT TRANSMITTING | 1.61736 | 1.61736 | 1.61736 | 1.61800 | 1.61673 | 1.61800 | 1.61673 |
| LAYER | | | | | | | |

TABLE 5
FIRST SURFACE (DIFFRACTIVE SURFACE)

| | |
|---|---|
| CURVATURE RADIUS | 0.9528088 |
| CONICAL COEFFICIENT | −0.712528 |
| ASPHERIC SURFACE COEFFICIENT OF 2ND ORDER | 0 |
| ASPHERIC SURFACE COEFFICIENT OF 4TH ORDER | 0.0673103 |
| ASPHERIC SURFACE COEFFICIENT OF 6TH ORDER | 0.0280522 |
| ASPHERIC SURFACE COEFFICIENT OF 8TH ORDER | −0.025986 |
| ASPHERIC SURFACE COEFFICIENT OF 10TH ORDER | 0.1149029 |
| ASPHERIC SURFACE COEFFICIENT OF 12TH ORDER | −0.173415 |
| ASPHERIC SURFACE COEFFICIENT OF 14TH ORDER | 0.167223 |
| ASPHERIC SURFACE COEFFICIENT OF 16TH ORDER | −0.114718 |
| ASPHERIC SURFACE COEFFICIENT OF 18TH ORDER | 0.0683144 |
| ASPHERIC SURFACE COEFFICIENT OF 20TH ORDER | −0.025121 |
| PHASE FUNCTION OF 2ND ORDER | −561.8305 |
| PHASE FUNCTION OF 4TH ORDER | 144.15425 |

TABLE 6
SECOND SURFACE (ASPHERIC SURFACE)

| | |
|---|---|
| CURVATURE RADIUS | −0.956977 |
| CONICAL COEFFICIENT | −24.75766 |
| ASPHERIC SURFACE COEFFICIENT OF 2ND ORDER | 0 |
| ASPHERIC SURFACE COEFFICIENT OF 4TH ORDER | 0.5250964 |
| ASPHERIC SURFACE COEFFICIENT OF 6TH ORDER | −1.378136 |
| ASPHERIC SURFACE COEFFICIENT OF 8TH ORDER | 0.6217015 |
| ASPHERIC SURFACE COEFFICIENT OF 10TH ORDER | 1.142131 |
| ASPHERIC SURFACE COEFFICIENT OF 12TH ORDER | 6.1109292 |
| ASPHERIC SURFACE COEFFICIENT OF 14TH ORDER | −27.40962 |
| ASPHERIC SURFACE COEFFICIENT OF 16TH ORDER | 37.172128 |
| ASPHERIC SURFACE COEFFICIENT OF 18TH ORDER | −17.59934 |

Note that the surface number in Table 3 represents, in order, the surfaces that the laser beam passed through, and surface number “0” represents the luminous point, surface number “1” represents the entrance surface (first surface) of the objective lens, surface number “2” represents the outgoing surface (second surface) of the objective lens, surface number “3” represents the surface of the multi-layer optical disc, and surface number “4” represents the information recording surface of the multi-layer optical disc.

What is unique about the objective lens of Example 1 is that the spherical aberration occurs on the over side when the wavelength of the laser beam shifts to the long-wavelength side. Since the spherical aberration which occurs due to a rise in temperature of the base lens is on the over side, the spherical aberration which occurs during a temperature change including a wavelength change is added, and occurs considerably on the over side. The minimum pitch of the diffractive structure is relatively large.

Subsequently, the objective lens of Example 2 is shown in Table 7 to Table 11 below. Table 7 is a table showing the specification of the objective lens in Example 2, Table 8 is a table showing the surface shape of the objective lens and the multi-layer optical disc in Example 2, Table 9 is a table showing the refractive index of the objective lens and the light transmitting layer relative to the wavelength and temperature in Example 2, Table 10 is a table showing the aspheric surface coefficient and the phase function of the first surface of the objective lens in Example 2, and Table 11 is a table showing the aspheric surface coefficient and the phase function of the second surface of the objective lens in Example 2.

TABLE 7

| | |
|---|---|
| WAVELENGTH (μm) | 0.405 |
| APERTURE (DIAMETER) (mm) | φ2.236 |
| NA | 0.86 |
| FOCAL DISTANCE (mm) | 1.30 |
| AXIAL CHROMATIC ABERRATION (μm/nm) | 0.10 |
| MINIMUM PITCH (μm) | 5 |
| DESIGN TEMPERATURE (° C.) | 40.00 |

TABLE 8

| | APEX | | | |
|---|---|---|---|---|
| | CURVA- | | | |
| SUR- | TURE | THICK- | | |
| FACE | RADIUS | NESS | | SURFACE |
| No. | (mm) | (mm) | MATERIAL | SHAPE |
| 0 | | ∞ | | |
| 1 | 0.87940779 | 1.803624 | | DIFFRACTIVE |
| | | | | SURFACE |
| 2 | −0.9167103 | 0.3 | OBJECTIVE | ASPHERIC |
| | | | LENS GLASS | SURFACE |
| | | | MATERIAL | |
| 3 | ∞ | 0.0875 | LIGHT | FLAT |
| | | | TRANS- | SURFACE |
| | | | MITTING | |
| | | | LAYER | |
| 4 | ∞ | | | FLAT |
| | | | | SURFACE |

TABLE 9

| | | | | | | | |
|---|---|---|---|---|---|---|---|
| WAVELENGTH (μm) | 0.405 | 0.405 | 0.405 | 0.403 | 0.407 | 0.403 | 0.407 |
| TEMPERATURE (° C.) | 10 | 40 | 80 | 40 | 40 | 0 | 80 |
| OBJECTIVE LENS | 1.52604 | 1.52228 | 1.51838 | 1.52258 | 1.52198 | 1.52634 | 1.52574 |
| GLASS MATERIAL | | | | | | | |
| LIGHT TRANSMITTING | 1.61736 | 1.61736 | 1.61736 | 1.61800 | 1.61673 | 1.61800 | 1.61673 |
| LAYER | | | | | | | |

TABLE 10
FIRST SURFACE (DIFFRACTIVE SURFACE)

| | |
|---|---|
| CURVATURE RADIUS | 0.87951065 |
| CONICAL COEFFICIENT | −0.77102763 |
| ASPHERIC SURFACE COEFFICIENT OF | 0 |
| 2ND ORDER | |
| ASPHERIC SURFACE COEFFICIENT OF | 0.039424164 |
| 4TH ORDER | |
| ASPHERIC SURFACE COEFFICIENT OF | 0.015796532 |
| 6TH ORDER | |
| ASPHERIC SURFACE COEFFICIENT OF | 0.017309211 |
| 8TH ORDER | |
| ASPHERIC SURFACE COEFFICIENT OF | −0.009827777 |
| 10TH ORDER | |
| ASPHERIC SURFACE COEFFICIENT OF | −0.031494188 |
| 12TH ORDER | |
| ASPHERIC SURFACE COEFFICIENT OF | 0.16376216 |
| 14TH ORDER | |
| ASPHERIC SURFACE COEFFICIENT OF | −0.26762659 |
| 16TH ORDER | |
| ASPHERIC SURFACE COEFFICIENT OF | 0.20440849 |
| 18TH ORDER | |
| ASPHERIC SURFACE COEFFICIENT OF | −0.063564362 |
| 20TH ORDER | |
| PHASE FUNCTION OF 2ND ORDER | −157.47241 |
| PHASE FUNCTION OF 4TH ORDER | −171.39705 |

TABLE 11
SECOND SURFACE (ASPHERIC SURFACE)

| | |
|---|---|
| CURVATURE RADIUS | −0.9172064 |
| CONICAL COEFFICIENT | −26.33746 |
| ASPHERIC SURFACE COEFFICIENT OF 2ND ORDER | 0 |
| ASPHERIC SURFACE COEFFICIENT OF 4TH ORDER | 0.49631387 |
| ASPHERIC SURFACE COEFFICIENT OF 6TH ORDER | −1.4810254 |
| ASPHERIC SURFACE COEFFICIENT OF 8TH ORDER | 1.667335 |
| ASPHERIC SURFACE COEFFICIENT OF 10TH ORDER | −2.2853187 |
| ASPHERIC SURFACE COEFFICIENT OF 12TH ORDER | 9.735954 |
| ASPHERIC SURFACE COEFFICIENT OF 14TH ORDER | −24.018386 |
| ASPHERIC SURFACE COEFFICIENT OF 16TH ORDER | 27.035924 |
| ASPHERIC SURFACE COEFFICIENT OF 18TH ORDER | −11.613882 |

Note that the surface number in Table 8 represents, in order, the surfaces that the laser beam passed through, and surface number “0” represents the luminous point, surface number “1” represents the entrance surface (first surface) of the objective lens, surface number “2” represents the outgoing surface (second surface) of the objective lens, surface number “3” represents the surface of the multi-layer optical disc, and surface number “4” represents the information recording surface of the multi-layer optical disc.

What is unique about the objective lens of Example 2 is that the spherical aberration which occurs when the wavelength of the laser beam shifts is extremely small. The minimum pitch of the diffractive structure is moderate.

Subsequently, the objective lens of Example 3 is shown in Table 12 to Table 16 below. Table 12 is a table showing the specification of the objective lens in Example 3, Table 13 is a table showing the surface shape of the objective lens and the multi-layer optical disc in Example 3, Table 14 is a table showing the refractive index of the objective lens and the light transmitting layer relative to the wavelength and temperature in Example 3, Table 15 is a table showing the aspheric surface coefficient and the phase function of the first surface of the objective lens in Example 3, and Table 16 is a table showing the aspheric surface coefficient and the phase function of the second surface of the objective lens in Example 3.

TABLE 12

| | |
|---|---|
| WAVELENGTH (μm) | 0.405 |
| APERTURE (DIAMETER) (mm) | φ2.236 |
| NA | 0.86 |
| FOCAL DISTANCE (mm) | 1.30 |
| AXIAL CHROMATIC ABERRATION (μm/nm) | 0.10 |
| MINIMUM PITCH (μm) | 3.0 |
| DESIGN TEMPERATURE (° C.) | 40.00 |

TABLE 13

| | APEX | | | |
|---|---|---|---|---|
| | CURVA- | | | |
| SUR- | TURE | THICK- | | |
| FACE | RADIUS | NESS | | SURFACE |
| No. | (mm) | (mm) | MATERIAL | SHAPE |
| 0 | | ∞ | | |
| 1 | 0.84627222 | 1.800317 | | DIFFRACTIVE |
| | | | | SURFACE |
| 2 | −0.9238417 | 0.3 | OBJECTIVE | ASPHERIC |
| | | | LENS GLASS | SURFACE |
| | | | MATERIAL | |
| 3 | ∞ | 0.0875 | LIGHT | FLAT |
| | | | TRANS- | SURFACE |
| | | | MITTING | |
| | | | LAYER | |
| 4 | ∞ | | | FLAT |
| | | | | SURFACE |

TABLE 14

| | | | | | | | |
|---|---|---|---|---|---|---|---|
| WAVELENGTH (μm) | 0.405 | 0.405 | 0.405 | 0.403 | 0.407 | 0.403 | 0.407 |
| TEMPERATURE (° C.) | 10 | 40 | 80 | 40 | 40 | 0 | 80 |
| OBJECTIVE LENS | 1.52604 | 1.52228 | 1.51838 | 1.52258 | 1.52198 | 1.52634 | 1.52574 |
| GLASS MATERIAL | | | | | | | |
| LIGHT TRANSMITTING | 1.61736 | 1.61736 | 1.61736 | 1.61800 | 1.61673 | 1.61800 | 1.61673 |
| LAYER | | | | | | | |

TABLE 15
FIRST SURFACE (DIFFRACTIVE SURFACE)

| | |
|---|---|
| CURVATURE RADIUS | 0.84627222 |
| CONICAL COEFFICIENT | −0.79850009 |
| ASPHERIC SURFACE COEFFICIENT OF | 0 |
| 2ND ORDER | |
| ASPHERIC SURFACE COEFFICIENT OF | 0.041137131 |
| 4TH ORDER | |
| ASPHERIC SURFACE COEFFICIENT OF | 0.008414394 |
| 6TH ORDER | |
| ASPHERIC SURFACE COEFFICIENT OF | 0.01010639 |
| 8TH ORDER | |
| ASPHERIC SURFACE COEFFICIENT OF | 0.005143514 |
| 10TH ORDER | |
| ASPHERIC SURFACE COEFFICIENT OF | −0.036682719 |
| 12TH ORDER | |
| ASPHERIC SURFACE COEFFICIENT OF | 0.11866753 |
| 14TH ORDER | |
| ASPHERIC SURFACE COEFFICIENT OF | −0.1769252 |
| 16TH ORDER | |
| ASPHERIC SURFACE COEFFICIENT OF | 0.132805 |
| 18TH ORDER | |
| ASPHERIC SURFACE COEFFICIENT OF | −0.042854864 |
| 20TH ORDER | |
| PHASE FUNCTION OF 2ND ORDER | 14.806009 |
| PHASE FUNCTION OF 4TH ORDER | −212.21215 |
| PHASE FUNCTION OF 6TH ORDER | −93.442405 |

TABLE 16
SECOND SURFACE (ASPHERIC SURFACE)

| | |
|---|---|
| CURVATURE RADIUS | −0.9238417 |
| CONICAL COEFFICIENT | −26.89365 |
| ASPHERIC SURFACE COEFFICIENT OF 2ND ORDER | 0 |
| ASPHERIC SURFACE COEFFICIENT OF 4TH ORDER | 0.5806088 |
| ASPHERIC SURFACE COEFFICIENT OF 6TH ORDER | −1.7269546 |
| ASPHERIC SURFACE COEFFICIENT OF 8TH ORDER | 1.2380161 |
| ASPHERIC SURFACE COEFFICIENT OF 10TH ORDER | 1.6164998 |
| ASPHERIC SURFACE COEFFICIENT OF 12TH ORDER | 2.2793591 |
| ASPHERIC SURFACE COEFFICIENT OF 14TH ORDER | −22.35474 |
| ASPHERIC SURFACE COEFFICIENT OF 16TH ORDER | 36.683971 |
| ASPHERIC SURFACE COEFFICIENT OF 18TH ORDER | −19.711221 |

Note that the surface number in Table 13 represents, in order, the surfaces that the laser beam passed through, and surface number “0” represents the luminous point, surface number “1” represents the entrance surface (first surface) of the objective lens, surface number “2” represents the outgoing surface (second surface) of the objective lens, surface number “3” represents the surface of the multi-layer optical disc, and surface number “4” represents the information recording surface of the multi-layer optical disc.

What is unique about the objective lens of Example 3 is that the spherical aberration occurs on the under side when the wavelength of the laser beam shifts to the long-wavelength side. Since the spherical aberration which occurs due to a temperature change of the base lens is on the over side, a part of the spherical aberration which occurs during a temperature change including a wavelength change is set off. The minimum pitch of the diffractive structure is relatively small.

The diffractive structure is now explained in detail. The first surface of the objective lens is divided into a plurality of areas into an orbicular zone shape from the optical axis toward a radial direction. A step that is parallel to the optical axis is provided between the mutually adjacent areas. These steps are of a depth that yields a phase difference of an integral multiple of the wavelength of the laser beam in the refractive index of the material corresponding to the design wavelength and the design temperature.

Specifically, the depth of the steps is the integral multiple of λ/(nd−1). Note that represents the wavelength of the laser beam, and nd represents the refractive index of the material. Thus, since the optical path difference that is provided by these steps will be an integral multiple of the wavelength of the laser beam, the wave fronts of the design wavelength and the design temperature that was transmitted through the diffractive lens are connected sequentially, and become a wave front that is free from aberration. Here, in terms of actual use, when the temperature rises from the design temperature, the refractive index of the material will decrease, and the optical path difference provided by the steps will also decrease. Thus, in the wave front shape of the spherical aberration which occurs during a rise in temperature, the wave front will be discontinuous due to the variation in the optical path difference of the phase steps. Nevertheless, this wave front becomes a shape in which the wave of the wave front shape is reduced, and on the whole the spherical aberration is reduced.

Moreover, when the wavelength of the laser beam fluctuates to the long-wavelength side simultaneously with the rise in temperature and the wavelength of the laser beam becomes longer than the design wavelength, the optical path difference that is given by the diffraction will decrease.

Here, normally, the chromatic aberration of an objective lens configured from an aspheric surface without a step structure will cause an over-side spherical aberration during a rise in temperature. Nevertheless, it is possible to cause an under-side spherical aberration by using the variation in the optical path difference during a temperature change based on the steps of the diffractive structure. Consequently, in terms of practical use, the spherical aberration which occurs during a temperature change will considerably decrease in comparison to a standard aspheric surface lens due to the foregoing effect. Accordingly, as a result of using the configuration of the objective lens of this Embodiment, aberration which occurs during a temperature change can be reduced and information can be recorded or reproduced favorably even when using a resin material that is superior in mass productiveness.

Moreover, as a result of the diffractive surface including a convex power, the spherical aberration which occurs when the wavelength of the laser beams shifts is corrected together with the longitudinal chromatic aberration.

In relation to the spherical aberration which occurs when the wavelength of the laser beam shifts, as the under-side spherical aberration which occurs based on only diffraction is increased, the over-side spherical aberration which occurs due to a temperature change can be decreased. Nevertheless, the foregoing case is undesirable since the orbicular zone width of the diffractive structure becomes narrow, the diffraction efficiency deteriorates, and the aberration degradation caused by the wavelength change becomes severe.

Accordingly, the amount of the under-side spherical aberration which occurs based on only diffraction is preferably the same as the amount of the over-side spherical aberration which is caused by the base lens. In other words, the absolute value of the spherical aberration which occurs due to the unit wavelength change in the overall diffractive lens is preferably small, and, for instance, the objective lens of Example 2 is preferably selected among the objective lenses having a diffractive structure shown in Example 1 to Example 3.

The objective lens of this Embodiment is configured as described below.

In other words, the objective lens is a single lens made of resin, and an orbicular zone-shaped diffractive structure is provided to at least one surface of the objective lens. The diffractive structure has a convex power, the orbicular zone width of the diffractive structure monotonically decreases from the center to the periphery of the objective lens, and a phase difference between the center and periphery of the objective lens is n times the wavelength λ of the laser beam. In addition, the objective lens satisfies following Formula (4) to Formula (8).

λ<450 [nm] (4)

NA>0.8 (5)

n/f>30 (6)

ΔCA≦ΔCA0/2 [μm/nm] (7)

|ΔSA(λ)/f|<0.003 [λ/(nm·mm)] (8)

where NA represents a numerical aperture, f represents a focal length, ΔCA represents a focal position variation (longitudinal chromatic aberration) per unit wavelength change of the objective lens, ΔCA0 represents a longitudinal chromatic aberration of 0-th order diffracted light of the objective lens, and ΔSA(λ) represents the 3rd order spherical aberration occurrence per unit wavelength change of the objective lens.

Moreover, the objective lens satisfies following Formula (9).

|ΔSA(t)/f<0.003 [λ/(° C.·mm)] (9)

where ΔSA(t) represents the 3rd order spherical aberration occurrence per unit temperature change.

In addition, the objective lens satisfies following Formula (10).

Δn>0.9×10⁻⁵ (10)

where Δn represents the refractive index change rate per unit temperature change of the material configuring the objective lens.

Furthermore, the objective lens satisfies following Formula (11).

νd<70 (11)

where νd represents the dispersion value of the material configuring the objective lens.

The objective lens of this Embodiment is now explained in detail with reference to the construction data, aberration diagram and the like. Note that, in each of Example 1 to Example 3, let it be assumed that the surface that is given the aspheric surface coefficient is a refractive optical surface having an aspheric surface shape or a surface (for instance, a diffractive surface) possessing a refractive effect that is equivalent to an aspheric surface, and shall be defined by following Formula (12) which represents the surface shape of the aspheric surface.

$$\begin{matrix}[ Equation 1 ] & \\ X = \frac{{C}_{j} {h}^{2}}{1 + \sqrt{1 - ( 1 + {k}_{j} ) {C}_{j}^{2} {h}^{2}}} + {\sum }^{ } {A}_{j , n} {h}^{n} & ( 12 )\end{matrix}$$

where X represents the distance from a tangent of an aspheric surface apex of an aspheric surface-shaped point in which the height from the optical axis is h, h represents the height from the optical axis, Cⱼ represents the curvature (Cⱼ=1/Rⱼ) of the aspheric surface apex of the j-th surface of the lens, Kⱼ represents the conic constant of the j-th surface of the lens, and A_{j, n} represents the n-th aspheric surface constant of the j-th surface of the lens, where j=1, 2, 3, 4 . . . .

Moreover, the phase difference that arises due to the diffractive structure added to the optical surface is given based on following Formula (13).

[Equation 2]

φ(h)=ΣP_{j,m}h^{2m} (13)

where φ(h) represents the phase function, h represents the height from the optical axis, and P_{j, m} represents the phase function coefficient of the 2m-th order of the j-th surface of the lens, where j=1, 2, 3, 4 . . . .

Here, the objective lens of Example 1 is explained with reference to foregoing Table 2 to Table 6.

In Example 1, the first surface 81 of the objective lens 8 is configured from a diffractive surface and the second surface 82 is configured from an aspheric surface. The design wavelength is 405 nm, the design temperature is 40° C., the focal length is 1.3 mm, the numerical aperture (NA) is 0.86, and the light transmitting layer thickness of the multi-layer optical disc is 0.0875 mm. The first surface 81 of the objective lens 8 is divided into a total of 76 areas, and each area is represented as a different aspheric surface. Moreover, the phase step between the respective areas is a depth corresponding to a single phase difference relative to the design wavelength.

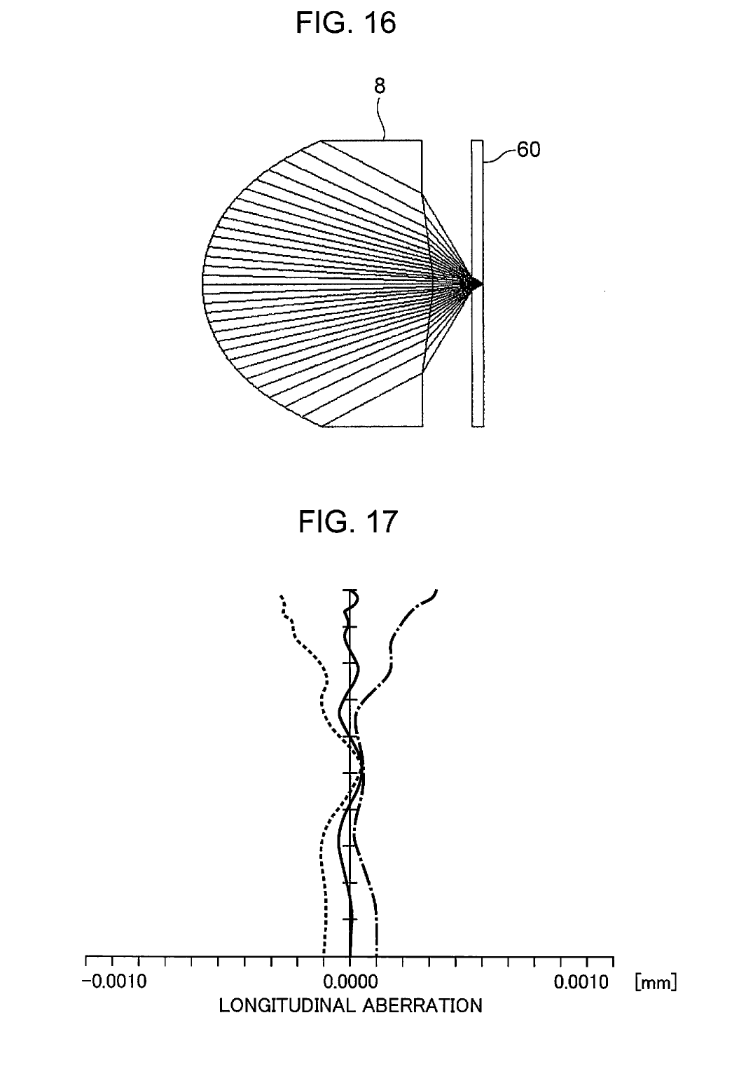

FIG. 16 is a diagram showing the optical path in the objective lens 8 having the diffractive structure of Example 1. FIG. 17 is a graph representing the longitudinal aberration (spherical aberration) when parallel light enters the objective lens 8 in the objective lens 8 having the diffractive structure of Example 1.

In FIG. 17, the solid line shows the longitudinal aberration of the objective lens when the wavelength of the laser beam is the design center wavelength of 405 nm, the dashed line shows the longitudinal aberration of the objective lens when the wavelength of the laser beam is 404 nm, and the dashed-dotted line shows the longitudinal aberration of the objective lens when the wavelength of the laser beam is 406 nm. In Example 1, an over-side spherical aberration occurs when the wavelength of the laser beam shifts to the long-wavelength side.

Table 17 is a table showing the amount of the 3rd order spherical aberration SA3 which occurs when the temperature and wavelength change in the objective lens of Example 1.

TABLE 17

| | TEMPERATURE | WAVELENGTH | SA3 |
|---|---|---|---|
| | (° C.) | (nm) | (mλ) |
| −2 nm | 40 | 403 | 35 |
| DESIGN CENTER | 40 | 405 | 0 |
| +2 nm | 40 | 407 | −34 |
| −40° C. | 0 | 405 | 155 |
| +40° C. | 80 | 405 | −152 |
| −2 nm, −40° C. | 0 | 403 | 191 |
| +2 nm, +40° C. | 80 | 407 | −185 |

Here, as the amount of the 3rd order spherical aberration SA3, a plus shows an under side (under-correction), and a minus shows an over side (over-correction).

When the wavelength of the laser beam changes +2 nm from the design center, the 3rd order spherical aberration SA3 occurs in an amount of approximately −34 mλ. Moreover, when the temperature changes +40° C., the 3rd order spherical aberration SA3 occurs in an amount of −152 mλ. Moreover, when the temperature changes +40° C. and the wavelength of the laser beam changes +2 nm from the design center, the 3rd order spherical aberration SA3 occurs in an amount of −185 mλ.

Here, the wavelength change rate relative to the temperature of the laser beam is +0.05 nm/° C. Moreover, the minimum pitch of diffraction of the objective lens of Example 1 is 10 μm, and large in comparison to the objective lenses of Example 2 and Example 3 described below.

Next, the objective lens of Example 2 is explained with reference to foregoing Table 7 to Table 11.

The first surface 81 of the objective lens 8 is configured from a diffractive surface and the second surface 82 is configured from an aspheric surface. The design wavelength is 405 nm, the design temperature is 40° C., the focal length is 1.3 mm, the numerical aperture (NA) is 0.86, and the light transmitting layer thickness of the multi-layer optical disc is 0.0875 mm. The first surface 81 of the objective lens 8 is divided into a total of 74 areas, and each area is represented as a different aspheric surface. Moreover, the phase step between the respective areas is a depth corresponding to a single phase difference relative to the design wavelength.

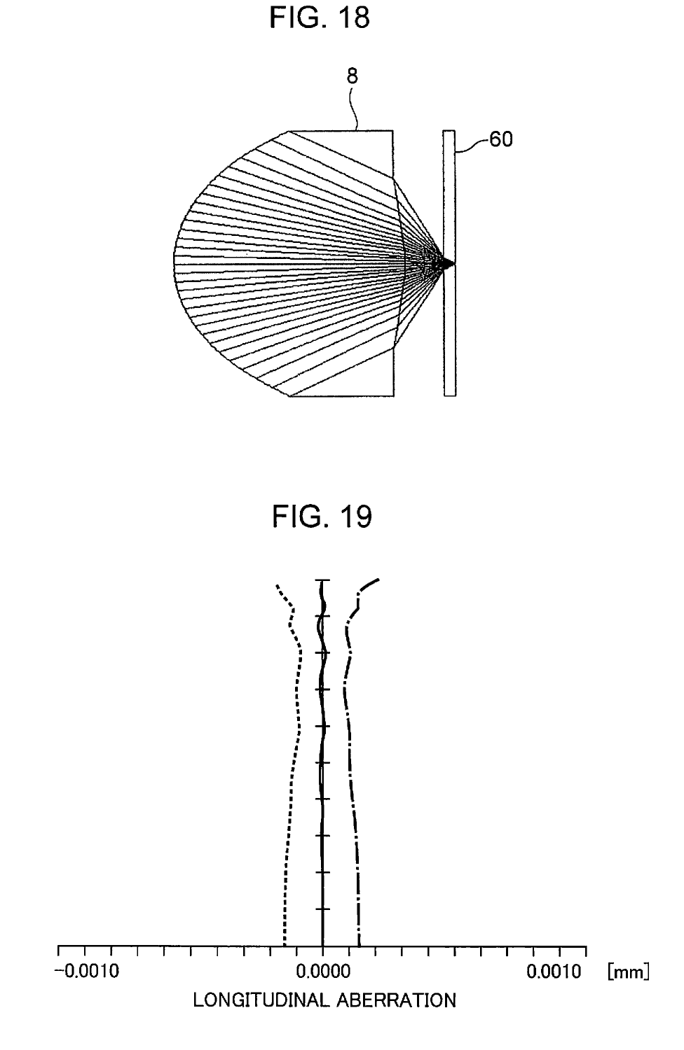

FIG. 18 is a diagram showing the optical path in the objective lens 8 having the diffractive structure of Example 2. FIG. 19 is a graph representing the longitudinal aberration (spherical aberration) when parallel light enters the objective lens 8 in the objective lens 8 having the diffractive structure of Example 2.

In FIG. 19, the solid line shows the longitudinal aberration of the objective lens when the wavelength of the laser beam is the design center wavelength of 405 nm, the dashed line shows the longitudinal aberration of the objective lens when the wavelength of the laser beam is 404 nm, and the dashed-dotted line shows the longitudinal aberration of the objective lens when the wavelength of the laser beam is 406 nm. In Example 2, the amount of spherical aberration that occurs when the wavelength of the laser beam shifts to the long-wavelength side is small.

Table 18 is a table showing the amount of the 3rd order spherical aberration SA3 which occurs when the temperature and wavelength change in the objective lens of Example 2.

TABLE 18

| | TEMPERATURE | WAVELENGTH | SA3 |
|---|---|---|---|
| | (° C.) | (nm) | (mλ) |
| −2 nm | 40 | 403 | 2 |
| DESIGN CENTER | 40 | 405 | 0 |
| +2 nm | 40 | 407 | −1 |
| −40° C. | 0 | 405 | 106 |
| +40° C. | 80 | 405 | −103 |
| −2 nm, −40° C. | 0 | 403 | 109 |
| +2 nm, +40° C. | 80 | 407 | −103 |

When the wavelength of the laser beam changes +2 nm from the design center, the 3rd order spherical aberration SA3 occurs in an amount of approximately −1 mλ. Moreover, when the temperature changes +40° C., the 3rd order spherical aberration SA3 occurs in an amount of −103 mλ. Moreover, when the temperature changes +40° C. and the wavelength of the laser beam changes +2 nm from the design center, the 3rd order spherical aberration SA3 occurs in an amount of −103 mλ.

The minimum pitch of diffraction of the objective lens of Example 2 is 5 μM, and is moderate in comparison to the objective lenses of Example 1 and Example 3.

Next, the objective lens of Example 3 is explained with reference to foregoing Table 12 to Table 16.

The first surface 81 of the objective lens 8 is configured from a diffractive surface and the second surface 82 is configured from an aspheric surface. The design wavelength is 405 nm, the design temperature is 40° C., the focal length is 1.3 mm, the numerical aperture (NA) is 0.86, and the light transmitting layer thickness of the multi-layer optical disc is 0.0875 mm. The first surface 81 of the objective lens 8 is divided into a total of 79 areas, and each area is represented as a different aspheric surface. Moreover, the phase step between the respective areas is a depth corresponding to a single phase difference relative to the design wavelength.

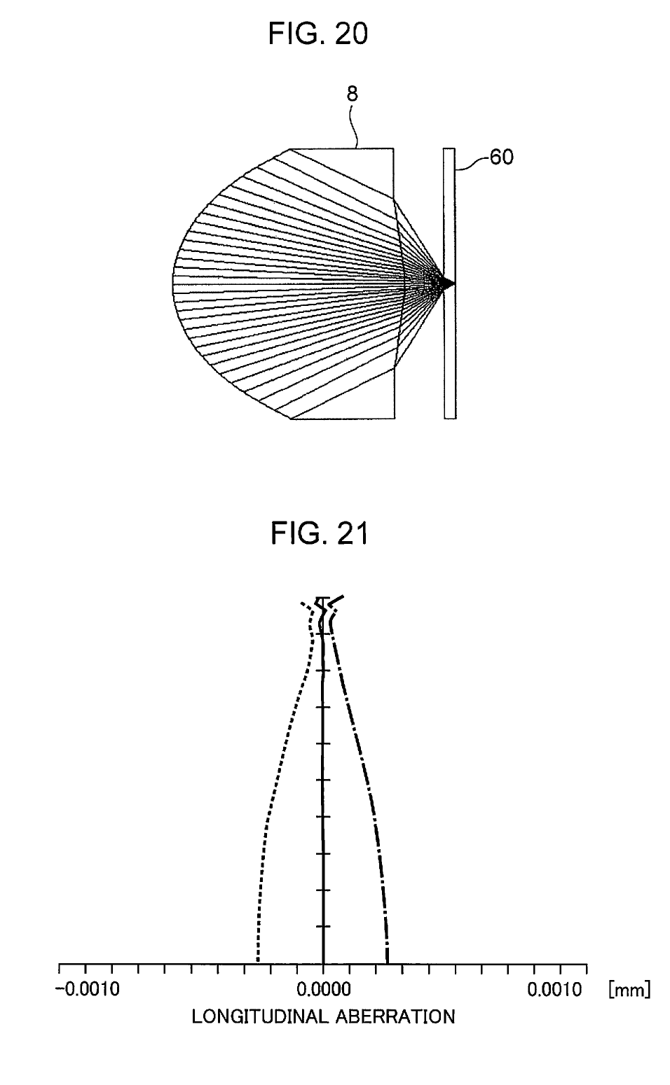

FIG. 20 is a diagram showing the optical path in the objective lens 8 having the diffractive structure of Example 3. FIG. 21 is a graph representing the longitudinal aberration (spherical aberration) when parallel light enters the objective lens 8 in the objective lens 8 having the diffractive structure of Example 3.

In FIG. 21, the solid line shows the longitudinal aberration of the objective lens when the wavelength of the laser beam is the design center wavelength of 405 nm, the dashed line shows the longitudinal aberration of the objective lens when the wavelength of the laser beam is 404 nm, and the dashed-dotted line shows the longitudinal aberration of the objective lens when the wavelength of the laser beam is 406 nm. In Example 3, an under-side spherical aberration occurs when the wavelength of the laser beam shifts to the long-wavelength side.

Table 19 is a table showing the amount of the 3rd order spherical aberration SA3 which occurs when the temperature and wavelength change in the objective lens of Example 3.

TABLE 19

| | TEMPERATURE | WAVELENGTH | SA3 |
|---|---|---|---|
| | (° C.) | (nm) | (mλ) |
| −2 nm | 40 | 403 | −21 |
| DESIGN CENTER | 40 | 405 | 0 |
| +2 nm | 40 | 407 | 21 |
| −40° C. | 0 | 405 | 73 |
| +40° C. | 80 | 405 | −69 |
| −2 nm, −40° C. | 0 | 403 | 53 |
| +2 nm, +40° C. | 80 | 407 | −48 |

When the wavelength of the laser beam changes +2 nm from the design center, the 3rd order spherical aberration SA3 occurs in an amount of approximately +21 mλ. Moreover, when the temperature changes +40° C., the 3rd order spherical aberration SA3 occurs in an amount of −69 mλ. Moreover, when the temperature changes +40° C. and the wavelength of the laser beam changes +2 nm from the design center, the 3rd order spherical aberration SA3 occurs in an amount of −48 mλ.

The minimum pitch of diffraction of the objective lens of Example 3 is 3 μM, and is small in comparison to the objective lenses of Example 1 and Example 2.

As described above, in this Embodiment 1, since a positive power component is added to the n-th order diffracted light, the longitudinal chromatic aberration can be corrected, and since a spherical aberration component is added to the n-th order diffracted light, the diffracted stray light that is reflected by an information recording surface other than the predetermined information recording surface will not be focused at one point due to the spherical aberration component, it is possible to reduce the interference of the signal light and the diffracted stray light, and thereby favorably record or reproduce information to or from an information recording medium including a plurality of information recording surfaces.

Note that, in Embodiment 1, the multi-layer optical disc includes four information recording surfaces, but the present invention is not limited thereto, and it may also be a multi-layer optical disc including two information recording surfaces. Even in cases where the multi-layer optical disc includes two information recording surfaces, the same effects as those described above are yielded. Moreover, the multi-layer optical disc may also include three information recording surfaces, or include five or more information recording surfaces. A greater effect is yielded when the multi-layer optical disc includes three or more information recording surfaces.

### Embodiment 2

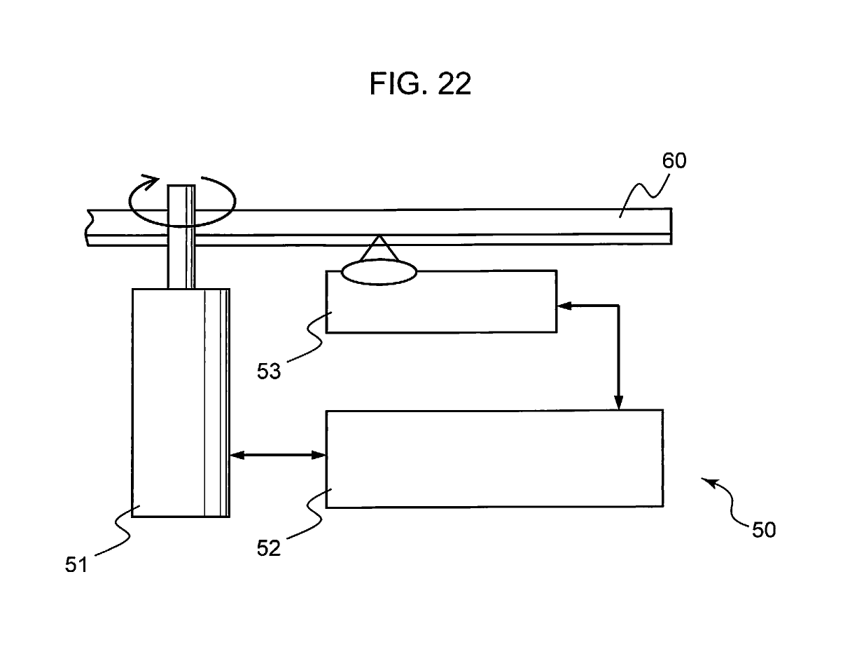

FIG. 22 is a diagram showing the schematic configuration of the optical disc device in Embodiment 2 of the present invention.

In FIG. 22, an optical disc device 50 internally comprises an optical disc drive unit 51, a control unit 52 and an optical head 53.

The optical disc drive unit 51 rotatably drives the multi-layer optical disc 60. The optical head 53 is the optical head described in Embodiment 1. The control unit 52 controls the drive of the optical disc drive unit 51 and the optical head 53, as well as performs the signal processing of control signals and information signals that were subject to photoelectric conversion by the optical head 53. Moreover, the control unit 52 also functions to interface the information signals at the outside and inside of the optical disc device 50.

Since the optical disc device 50 of Embodiment 2 is equipped with the optical head described in Embodiment 1, it is suitable for favorably recording or reproducing information to or from a multi-layer optical disc, and a compact configuration can also be realized.

### Embodiment 3

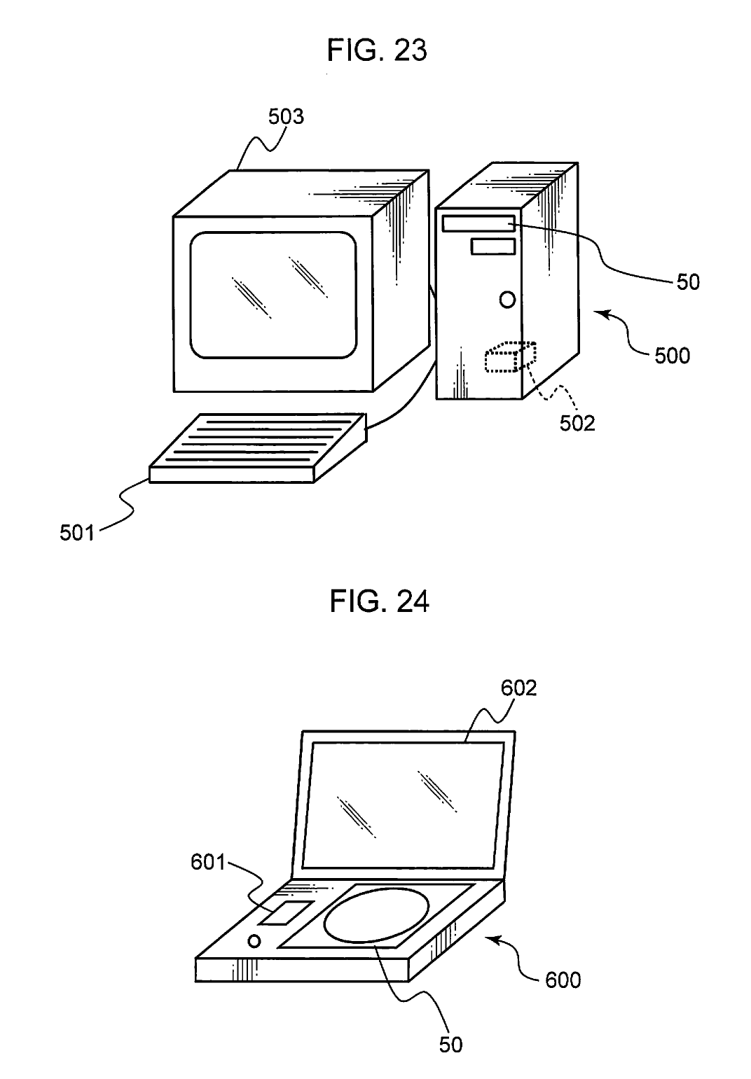

FIG. 23 is a diagram showing the schematic configuration of the computer in Embodiment 3 of the present invention.

In FIG. 23, a computer 500 comprises the optical disc device 50 of Embodiment 2, an input device 501 such as a keyboard, a mouse or a touch panel for inputting information, an arithmetic device 502 such as a central processing unit (CPU) for performing operations based on information input from the input device 501 and information read from the optical disc device 50, and an output device 503 such as a cathode-ray tube or a liquid crystal display device for displaying information related to the results that were operated by the arithmetic device 502 or a printer for printing such information.

Note that, in Embodiment 3, the computer 500 corresponds to an example of the information processing device, and the arithmetic device 502 corresponds to an example of the information processing unit.

Since the computer 500 comprises the optical disc device 50 of Embodiment 2, it is suitable for favorably recording or reproducing information to or from a multi-layer optical disc, and a compact configuration can also be realized.

### Embodiment 4

FIG. 24 is a diagram showing the schematic configuration of the optical disc player in Embodiment 4 of the present invention.

In FIG. 24, an optical disc player 600 comprises the optical disc device 50 of Embodiment 2, and a decoder 601 for converting information signals obtained from the optical disc device 50 into image signals.

Note that the optical disc player 600 can also be used as a car navigation system by adding a position sensor such as a GPS and a central processing unit (CPU). Moreover, the optical disc player 600 may also comprise a display device 602 such as a liquid crystal monitor.

Moreover, in Embodiment 4, the optical disc player 600 corresponds to an example of the information processing device, and the decoder 601 corresponds to an example of the information processing unit.

Since the optical disc player 600 comprises the optical disc device 50 of Embodiment 2, it is suitable for favorably recording or reproducing information to or from a multi-layer optical disc, and a compact configuration can also be realized.

### Embodiment 5

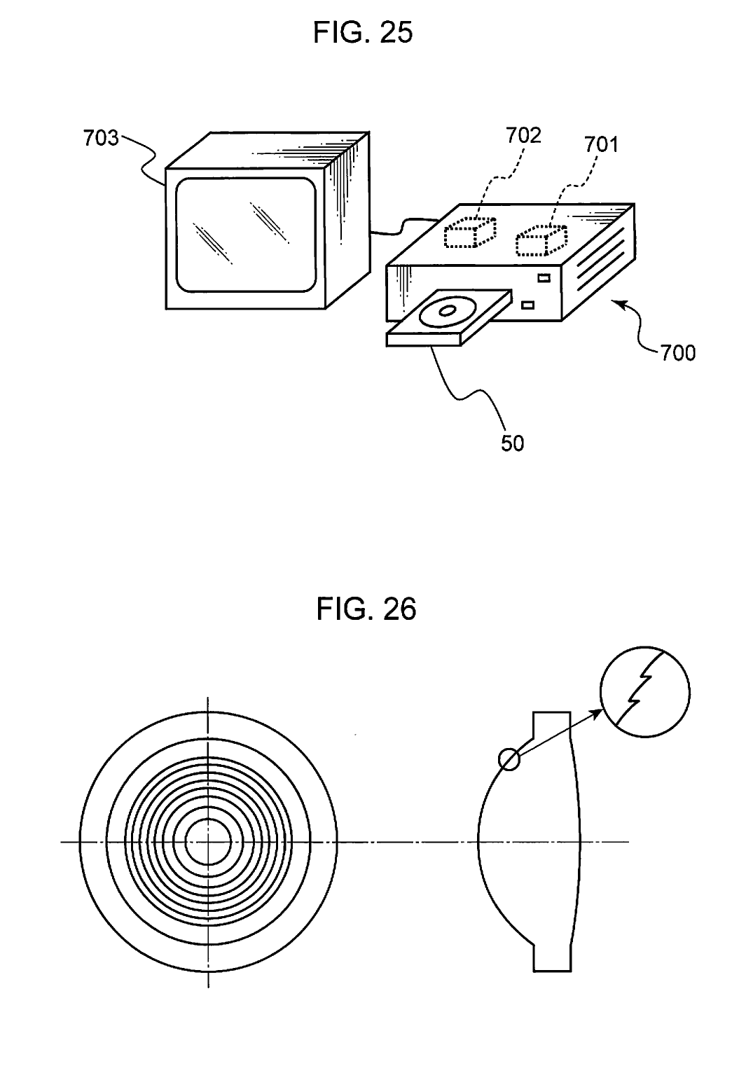

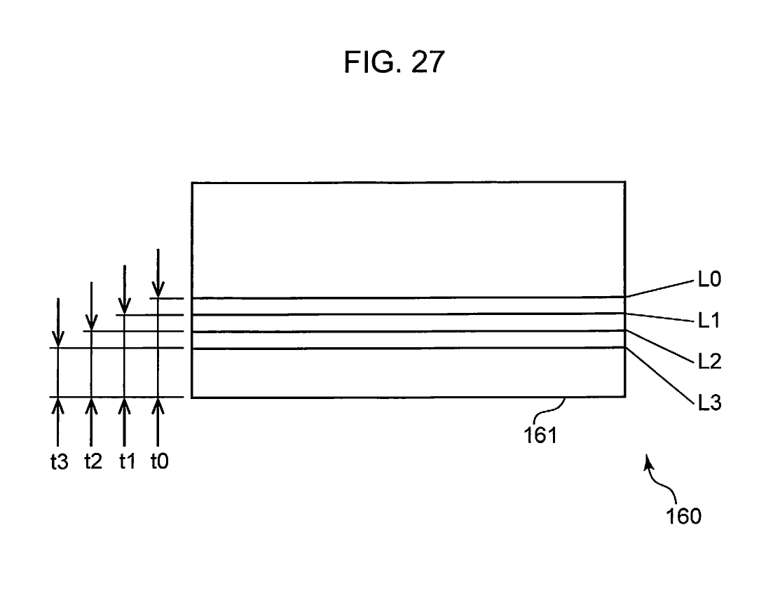

FIG. 25 is a diagram showing the schematic configuration of the optical disc recorder in Embodiment 5 of the present invention.

In FIG. 25, an optical disc recorder 700 comprises the optical disc device 50 of Embodiment 2, and an encoder 701 for converting image information into information signals for recording on an optical disc by the optical disc device 50. Desirably, a decoder 702 for converting information signals obtained from the optical disc device 50 into image information is additionally provided so as to enable the reproduction of the recorded image. Note that the optical disc recorder 700 may also comprise an output device 703 such as a cathode-ray tube or a liquid crystal display device for displaying information, or a printer for printing information.

Note that, in Embodiment 5, the optical disc recorder 700 corresponds to an example of the information processing device, and the encoder 701 and the decoder 702 correspond to an example of the information processing unit.

Since the optical disc recorder 700 comprises the optical disc device 50 of Embodiment 2, it is suitable for favorably recording or reproducing information to or from a multi-layer optical disc, and a compact configuration can also be realized.

Note that the specific embodiments described above mainly include the invention configured as described below.

The optical head according to one aspect of the present invention is an optical head for recording or reproducing information to or from an information recording medium including a plurality of information recording surfaces, this optical head including: a light source which emits a laser beam; an objective lens which has an orbicular zone-shaped diffractive structure, and which diffracts the laser beam and converges the generated diffracted light of n-th order (where n is a natural number) on a predetermined information recording surface of the information recording medium; and a photodetector which receives the laser beam reflected by the predetermined information recording surface, wherein the diffractive structure adds a positive power component and a spherical aberration component to the n-th order diffracted light.

According to the foregoing configuration, the light source emits a laser beam. The objective lens has an orbicular zone-shaped diffractive structure, and diffracts the laser beam and converges the generated diffracted light of n-th order (where n is a natural number) on a predetermined information recording surface of the information recording medium. The photodetector receives the laser beam that was reflected by the predetermined information recording surface. In addition, the diffractive structure adds a positive power component and a spherical aberration component to the n-th order diffracted light.

Accordingly, since a positive power component is added to the n-th order diffracted light, the longitudinal chromatic aberration can be corrected, and since a spherical aberration component is added to the n-th order diffracted light, the diffracted stray light that is reflected by an information recording surface other than the predetermined information recording surface will not be focused at one point due to the spherical aberration component, it is possible to reduce the interference of the signal light and the diffracted stray light, and thereby favorably record or reproduce information to or from an information recording medium including a plurality of information recording surfaces.

Moreover, in the foregoing optical head, preferably, the spherical aberration component added by the diffractive structure has spherical aberration characteristics where the spherical aberration changes in a direction of under-correction when a wavelength of the laser beam emitted from the light source shifts to a long-wavelength side.

According to the foregoing configuration, since the spherical aberration component added by the diffractive structure has spherical aberration characteristics where the spherical aberration changes in a direction of under-correction when a wavelength of the laser beam emitted from the light source shifts to a long-wavelength side, the change in the spherical aberration of the objective lens that will be over-corrected due to a rise in temperature can be negated with the change in the spherical aberration which occurs pursuant to the wavelength shift of the light source due to a rise in temperature.

Moreover, in the foregoing optical head, preferably, the information recording medium includes three or more information recording surfaces, and the spherical aberration component added by the diffractive structure satisfies following Formula (14).

SA1≅−SA2 (14)

where SA1 represents the spherical aberration which occurs due to a change in the diffraction angle caused by the diffractive structure pursuant to a unit wavelength change in the laser beam emitted from the light source, and SA2 represents the spherical aberration which occurs due to a change in the refractive index of the objective lens pursuant to a unit wavelength change in the laser beam emitted from the light source.

According to the foregoing configuration, since the information recording medium includes three or more information recording surfaces, and the spherical aberration component added by the diffractive structure satisfies foregoing Formula (14), the spherical aberration which occurs due to a change in the diffraction angle caused by the diffractive structure pursuant to a unit wavelength change in the laser beam emitted from the light source and the spherical aberration which occurs due to a change in the refractive index of the object lens pursuant to a unit wavelength change in the laser beam emitted from the light source are set off, and the spherical aberration which occurs during a wavelength change can be reduced.

Moreover, in the foregoing optical head, preferably, the spherical aberration component added by the diffractive structure satisfies following Formula (15).

0.8×|SA1|≦|SA2|≦1.2×|SA1| (15)

where SA1 represents the spherical aberration which occurs due to a change in the diffraction angle caused by the diffractive structure pursuant to a unit wavelength change in the laser beam emitted from the light source, SA2 represents the spherical aberration which occurs due to a change in the refractive index of the objective lens pursuant to a unit wavelength change in the laser beam emitted from the light source, and SA1 and SA2 have polarities opposite to each other.

According to the foregoing configuration, since the spherical aberration component added by the diffractive structure satisfies foregoing Formula (15), the spherical aberration which occurs due to a change in the diffraction angle caused by the diffractive structure pursuant to a unit wavelength change in the laser beam emitted from the light source and the spherical aberration which occurs due to a change in the refractive index of the objective lens pursuant to a unit wavelength change in the laser beam emitted from the light source are substantially set off, and the spherical aberration which occurs during a wavelength change can be reduced.

Moreover, in the foregoing optical head, preferably, the objective lens reduces a change in the converged position of the laser beam which occurs pursuant to a wavelength change of the laser beam emitted from the light source, and a variation D [μm/nm] of the converged position of the laser beam which occurs pursuant to a unit wavelength change in the laser beam emitted from the light source satisfies following Formula (16).

0.05 [μm/nm]≦D≦0.15 [μm/nm] (16)

According to the foregoing configuration, a change in the converged position of the laser beam which occurs pursuant to a wavelength change of the laser beam emitted from the light source is reduced by the longitudinal chromatic aberration correction function of the objective lens. Moreover, a variation D [μm/nm] of the converged position of the laser beam which occurs pursuant to a unit wavelength change in the laser beam emitted from the light source satisfies foregoing Formula (16).

Accordingly, a change in the converged position which occurs due to the wavelength fluctuation of the laser beam emitted from the light source upon switching the recording power and the reproduction power or upon any change in the ambient temperature can be favorably corrected.

Moreover, in the foregoing optical head, preferably, when an optical path difference function Φ(h) which represents an addition of the optical path length caused by the diffractive structure is represented as Φ(h)=P₂×h²+P₄×h⁴+P₆×h⁶+ . . . +P₂ₖ×h^{2k} (where k is a natural number), and a power φ_{D} of the lens caused by the diffractive structure is represented as φ_{D}=−(2×P₂×n×λ), the power φ_{D} of the lens caused by the diffractive structure, and a power φ_{R} of an underlying refractive lens excluding the diffractive structure in the objective lens satisfy following Formula (17).

0.004≦φ_{D}/φ_{R}≦0.020 (17)

where h represents a height from an optical axis, n represents a diffractive order, P₂, P₄, P₆, . . . , P2k represent a coefficient, and λ represents a wavelength of the laser beam.

According to the foregoing configuration, since power φ_{D} of the lens caused by the diffractive structure, and a power φ_{R} of an underlying refractive lens excluding the diffractive structure in the objective lens satisfy foregoing Formula (17), a change in the converged position which occurs due to the wavelength fluctuation of the laser beam emitted from the light source upon switching the recording power and the reproduction power or upon any change in the ambient temperature can be favorably corrected.

Moreover, preferably, the foregoing optical head further comprises a coupling lens disposed between the light source and the objective lens, and a spherical aberration correction unit for correcting, by moving the coupling lens in an optical axis direction, the spherical aberration which occurs according to a length of a distance from a light entrance surface of the information recording medium to the information recording surface.

According to the foregoing configuration, a coupling lens is disposed between the light source and the objective lens, and a spherical aberration correction unit corrects, by moving the coupling lens in an optical axis direction, the spherical aberration which occurs according to a length of a distance from a light entrance surface of the information recording medium to the information recording surface. Accordingly, the spherical aberration which occurs according to a length of a distance from a light entrance surface of the information recording medium to the information recording surface can be corrected.

Moreover, in the foregoing optical head, preferably, the objective lens is a single lens made of resin.

According to the foregoing configuration, since the objective lens is a single lens made of resin, the specific gravity is small in comparison to a glass objective lens, and the burden of the objective lens actuator for performing focus servo or tracking servo can be alleviated. Moreover, mass production is enabled with a high degree of accuracy via injection molding, and this is suitable for cost reduction.

Moreover, in the foregoing optical head, preferably, a minimum pitch of the diffractive structure of the objective lens is 5 μm or more.

According to the foregoing configuration, since a minimum pitch of the diffractive structure of the objective lens is 5 μm or more, deterioration in the transcription of injection molding and deterioration in the diffraction efficiency caused by the narrowing of the pitch can be inhibited.

The optical disc device according to another aspect of the present invention comprises any one of the foregoing optical heads, a drive unit for rotatably driving an information recording medium, and a control unit for controlling the optical head and the drive unit. According to the foregoing configuration, the foregoing optical head can be applied to the optical disc device.

The information processing device according to another aspect of the present invention comprises the foregoing optical disc device, and an information processing unit for processing information recorded in the optical disc device and/or information reproduced from the optical disc device. According to the foregoing configuration, the optical disc device comprising the foregoing optical head can be applied to the information processing device.

The objective lens according to another aspect of the present invention is an objective lens provided in an optical head for recording or reproducing information to or from an information recording medium including a plurality of information recording surfaces, this objective lens including: an orbicular zone-shaped diffractive structure which diffracts a laser beam and converges the generated diffracted light of n-th order (where n is a natural number) on a predetermined information recording surface of the information recording medium, wherein the diffractive structure adds a positive power component and a spherical aberration component to the n-th order diffracted light.

According to the foregoing configuration, an orbicular zone-shaped diffractive structure diffracts the laser beam and converges the generated diffracted light of n-th order (where n is a natural number) on a predetermined information recording surface of the information recording medium. In addition, the diffractive structure adds a positive power component and a spherical aberration component to the n-th order diffracted light.

Accordingly, since a positive power component is added to the n-th order diffracted light, the longitudinal chromatic aberration can be corrected, and since a spherical aberration component is added to the n-th order diffracted light, the diffracted stray light that is reflected by an information recording surface other than the predetermined information recording surface will not be focused at one point due to the spherical aberration component, and it is possible to reduce the interference of the signal light and the diffracted stray light.

Moreover, in the foregoing objective lens, preferably, the spherical aberration component added by the diffractive structure has spherical aberration characteristics where the spherical aberration changes in a direction of under-correction when a wavelength of the laser beam shifts to a long-wavelength side.

According to the foregoing configuration, since the spherical aberration component added by the diffractive structure has spherical aberration characteristics where the spherical aberration changes in a direction of under-correction when a wavelength of the laser beam emitted from the light source shifts to a long-wavelength side, the change in the spherical aberration of the objective lens that will be over-corrected due to a rise in temperature can be negated with the change in the spherical aberration which occurs pursuant to the wavelength shift of the light source due to a rise in temperature.

Moreover, in the foregoing objective lens, preferably, the information recording medium includes three information recording surfaces, and the spherical aberration component added by the diffractive structure satisfies following Formula (18).

SA1≅−SA2 (18)

where SA1 represents the spherical aberration which occurs due to a change in the diffraction angle caused by the diffractive structure pursuant to a unit wavelength change in the laser beam emitted from the light source, and SA2 represents the spherical aberration which occurs due to a change in the refractive index of the objective lens pursuant to a unit wavelength change in the laser beam emitted from the light source.

According to the foregoing configuration, since the information recording medium includes three information recording surfaces, and the spherical aberration component added by the diffractive structure satisfies foregoing Formula (18), the spherical aberration which occurs due to a change in the diffraction angle caused by the diffractive structure pursuant to a unit wavelength change in the laser beam emitted from the light source and the spherical aberration which occurs due to a change in the refractive index of the object lens pursuant to a unit wavelength change in the laser beam emitted from the light source are set off, and the spherical aberration which occurs during a wavelength change can be reduced.

Moreover, in the foregoing objective lens, preferably, the spherical aberration component added by the diffractive structure satisfies following Formula (19).

0.8×|SA1|≦|SA2|≦1.2×|SA1| (19)

where SA1 represents the spherical aberration which occurs due to a change in the diffraction angle caused by the diffractive structure pursuant to a unit wavelength change in the laser beam emitted from the light source, SA2 represents the spherical aberration which occurs due to a change in the refractive index of the objective lens pursuant to a unit wavelength change in the laser beam emitted from the light source, and SA1 and SA2 have polarities opposite to each other.

According to the foregoing configuration, since the spherical aberration component added by the diffractive structure satisfies foregoing Formula (19), the spherical aberration which occurs due to a change in the diffraction angle caused by the diffractive structure pursuant to a unit wavelength change in the laser beam emitted from the light source and the spherical aberration which occurs due to a change in the refractive index of the objective lens pursuant to a unit wavelength change in the laser beam emitted from the light source are substantially set off, and the spherical aberration which occurs during a wavelength change can be reduced.

Moreover, in the foregoing objective lens, preferably, the objective lens reduces a change in the converged position of the laser beam which occurs pursuant to a wavelength change of the laser beam, and a variation D [μm/nm] of the converged position of the laser beam which occurs pursuant to a unit wavelength change in the laser beam following Formula (20).

0.05 [μm/nm]≦D≦0.15 [μm/nm] (20)

According to the foregoing configuration, a change in the converged position of the laser beam which occurs pursuant to a wavelength change of the laser beam emitted from the light source is reduced by the longitudinal chromatic aberration correction function of the objective lens. Moreover, a variation D [μm/nm] of the converged position of the laser beam which occurs pursuant to a unit wavelength change in the laser beam emitted from the light source satisfies foregoing Formula (20).

Accordingly, a change in the converged position which occurs due to the wavelength fluctuation of the laser beam emitted from the light source upon switching the recording power and the reproduction power or upon any change in the ambient temperature can be favorably corrected.

Moreover, in the foregoing objective lens, preferably, when an optical path difference function Φ(h) which represents an addition of the optical path length caused by the diffractive structure is represented as Φ(h)=P₂×h²+P₄×h⁴+P₆×h⁶+ . . . +P₂ₖ×h^{2k} (where k is a natural number), and a power φ_{D} of the lens caused by the diffractive structure is represented as φ_{D}=−(2×P₂×n×λ), the power φ_{D} of the lens caused by the diffractive structure, and a power φ_{R} of an underlying refractive lens excluding the diffractive structure in the objective lens satisfy following Formula (21).

0.004≦φ_{D}/φ_{R}≦0.020 (21)

where h represents a height from an optical axis, n represents a diffractive order, P₂, P₄, P₆, . . . , P₂ₖ represent a coefficient, and λ represents a wavelength of the laser beam.

According to the foregoing configuration, since power φ_{D} of the lens caused by the diffractive structure, and a power φ_{R} of an underlying refractive lens excluding the diffractive structure in the objective lens satisfy foregoing Formula (21), a change in the converged position which occurs due to the wavelength fluctuation of the laser beam emitted from the light source upon switching the recording power and the reproduction power or upon any change in the ambient temperature can be favorably corrected.

The objective lens according to another aspect of the present invention is an objective lens provided in an optical head for recording or reproducing information to or from an information recording medium including a plurality of information recording surfaces, wherein the objective lens is a single lens made of resin, wherein an orbicular zone-shaped diffractive structure is provided to at least one surface of the objective lens, wherein the diffractive structure has a convex power, wherein the orbicular zone width of the diffractive structure monotonically decreases from the center to the periphery of the objective lens, wherein a phase difference between the center and periphery of the objective lens is n times the wavelength λ of the laser beam, and wherein the objective lens satisfies following Formula (22) to Formula (26).

λ<450 [nm] (22)

NA>0.8 (23)

n/f>30 (24)

|ΔCA≦ΔCA0/2 [μm/nm] (25)

|ΔSA(λ)/f|<0.003 [λ/(nm·mm)] (26)

where NA represents a numerical aperture, f represents a focal length, ΔCA represents an longitudinal chromatic aberration per unit wavelength change of the objective lens, ΔCA0 represents a longitudinal chromatic aberration of 0-th order diffracted light of the objective lens, and ΔSA(λ) represents a 3rd order spherical aberration occurrence per unit wavelength change of the objective lens.

According to the foregoing configuration, the objective lens is a single lens made of resin, and orbicular zone-shaped diffractive structure is provided to at least one surface of the objective lens. The diffractive structure has a convex power, the orbicular zone width of the diffractive structure monotonically decreases from the center to the periphery of the objective lens, and a phase difference between the center and periphery of the objective lens is n times the wavelength λ of the laser beam. In addition, the objective lens satisfies foregoing Formula (22) to Formula (26).

Accordingly, it is possible to correct the longitudinal chromatic aberration and reduce the spherical aberration which occurs when the wavelength is shifted, and thereby favorably record or reproduce information to or from an information recording medium including a plurality of information recording surfaces.

Moreover, in the foregoing objective lens, preferably, the objective lens satisfies following Formula (27).

|ΔSA(t)/f|<0.003 [λ/(° C.·mm)] (27)

where ΔSA(t) represents the 3rd order spherical aberration occurrence per unit temperature change.

According to the foregoing configuration, as a result of the objective lens satisfying foregoing Formula (27), it is possible to correct the longitudinal chromatic aberration and reduce the spherical aberration which occurs when the wavelength is shifted, and thereby favorably record or reproduce information to or from an information recording medium including a plurality of information recording surfaces.

Moreover, in the foregoing objective lens, preferably, the objective lens satisfies following Formula (28).

Δn>0.9×10⁻⁵ (28)

where Δn represents the refractive index change rate per unit temperature change of the material configuring the objective lens.

According to the foregoing configuration, as a result of the objective lens satisfying foregoing Formula (28), it is possible to correct the longitudinal chromatic aberration and reduce the spherical aberration which occurs when the wavelength is shifted, and thereby favorably record or reproduce information to or from an information recording medium including a plurality of information recording surfaces.

Moreover, in the foregoing objective lens, preferably, the objective lens satisfies following Formula (29).

νd<70 (29)

where νd represents the dispersion value of the material configuring the objective lens.

According to the foregoing configuration, as a result of the objective lens satisfying foregoing Formula (29), it is possible to correct the longitudinal chromatic aberration and reduce the spherical aberration which occurs when the wavelength is shifted, and thereby favorably record or reproduce information to or from an information recording medium including a plurality of information recording surfaces.

Note that the specific Embodiments and Examples described in the foregoing section of Description of Embodiments are merely for clarifying the technical contents of the present invention, and the present invention should not be narrowly interpreted by being limited to such specific examples. Thus, this invention can be variously modified and implemented within the scope of the spirit and claims of the present invention.

### INDUSTRIAL APPLICABILITY

The optical head, the optical disc device, the information processing device and the objective lens of the present invention can favorably record or reproduce information to or from an information recording medium including a plurality of information recording surfaces, and can be suitably applied to an optical head which records or reproduces information to or from an information recording medium, an optical disc device comprising the foregoing optical head, an information processing device comprising the foregoing optical disc device, and an objective lens for use in the foregoing optical head.

1-13. (canceled)

14. An optical head for recording or reproducing information to or from an information recording medium including three or more information recording surfaces,
the optical head comprising:
a light source which emits a laser beam;
an objective lens which is made of resin, has an orbicular zone-shaped diffractive structure, and diffracts the laser beam and converges the generated diffracted light of n-th order (where n is a natural number) on a predetermined information recording surface of the information recording medium; and
a photodetector which receives the laser beam reflected by the predetermined information recording surface, wherein
the diffractive structure adds a positive power component and a spherical aberration component to the n-th order diffracted light,
the spherical aberration component added by the diffractive structure has spherical aberration characteristics where the spherical aberration changes in a direction of under-correction when a wavelength of the laser beam emitted from the light source shifts to a long-wavelength side, and
the spherical aberration component added by the diffractive structure satisfies following Formula (1):
SA1≅−SA2 (1)
where SA1 represents the spherical aberration which occurs due to a change in the diffraction angle caused by the diffractive structure pursuant to a unit wavelength change in the laser beam emitted from the light source, and SA2 represents the spherical aberration which occurs due to a change in the refractive index of the objective lens pursuant to a unit wavelength change in the laser beam emitted from the light source.

15. An optical head for recording or reproducing information to or from an information recording medium including three or more information recording surfaces,
the optical head comprising:
a light source which emits a laser beam;
an objective lens which is made of resin, has an orbicular zone-shaped diffractive structure, and diffracts the laser beam and converges the generated diffracted light of n-th order (where n is a natural number) on a predetermined information recording surface of the information recording medium; and
a photodetector which receives the laser beam reflected by the predetermined information recording surface, wherein
the diffractive structure adds a positive power component and a spherical aberration component to the n-th order diffracted light,
the spherical aberration component added by the diffractive structure has spherical aberration characteristics where the spherical aberration changes in a direction of under-correction when a wavelength of the laser beam emitted from the light source shifts to a long-wavelength side, and
wherein the spherical aberration component added by the diffractive structure satisfies following Formula (2):
0.8×|SA1|≦|SA2|≦1.2×|SA1| (2)
where, SA1 represents the spherical aberration which occurs due to a change in the diffraction angle caused by the diffractive structure pursuant to a unit wavelength change in the laser beam emitted from the light source, SA2 represents the spherical aberration which occurs due to a change in the refractive index of the objective lens pursuant to a unit wavelength change in the laser beam emitted from the light source, and SA1 and SA2 have polarities opposite to each other.

16. The optical head according to claim 14,
wherein the objective lens reduces a change in the converged position of the laser beam which occurs pursuant to a wavelength change of the laser beam emitted from the light source, and a variation D [μm/nm] of the converged position of the laser beam which occurs pursuant to a unit wavelength change in the laser beam emitted from the light source satisfies following Formula (3):
0.05 [μm/nm]≦D≦0.15 [μm/nm] (3)

17. The optical head according to claim 14, wherein, when an optical path difference function Φ(h) which represents an addition of the optical path length caused by the diffractive structure is represented as
Φ(h)=P₂×h²+P₄×h⁴+P₆×h⁶+ . . . +P₂ₖ×h^{2k} (where k is a natural number), and a power φ_{D} of the lens caused by the diffractive structure is represented as φ_{D}=−(2×P₂×n×λ),
the power φ_{D} of the lens caused by the diffractive structure, and a power φ_{R} of an underlying refractive lens excluding the diffractive structure in the objective lens satisfy following Formula (4).
0.004≦φ_{D}/φ_{R}≦0.020 (4):
where, h represents a height from an optical axis, n represents a diffractive order, P₂, P₄, P₆, . . . , P₂ₖ represent a coefficient, and λ represents a wavelength of the laser beam.

18. The optical head according to claim 14, further comprising:
a coupling lens disposed between the light source and the objective lens; and
a spherical aberration correction unit for correcting, by moving the coupling lens in an optical axis direction, the spherical aberration which occurs according to a length of a distance from a light entrance surface of the information recording medium to the information recording surface.

19. The optical head according to claim 14, wherein the objective lens is a single lens made of resin.

20. The optical head according to claim 14, wherein a minimum pitch of the diffractive structure of the objective lens is 5 μm or more.

21. An optical disc device, comprising:
the optical head according to claim 14;
a drive unit for rotatably driving an information recording medium; and
a control unit for controlling the optical head and the drive unit.

22. An information processing device, comprising:
the optical disc device according to claim 21; and
an information processing unit for processing information recorded in the optical disc device and/or information reproduced from the optical disc device.

23. An objective lens made of resin provided in an optical head for recording or reproducing information to or from an information recording medium including three or more information recording surfaces,
the objective lens comprising:
an orbicular zone-shaped diffractive structure which diffracts a laser beam and converges the generated diffracted light of n-th order (where n is a natural number) on a predetermined information recording surface of the information recording medium, wherein
the diffractive structure adds a positive power component and a spherical aberration component to the n-th order diffracted light,
the spherical aberration component added by the diffractive structure has spherical aberration characteristics where the spherical aberration changes in a direction of under-correction when a wavelength of the laser beam shifts to a long-wavelength side, and
the spherical aberration component added by the diffractive structure satisfies following Formula (5):
SA1≅−SA2 (5)
where, SA1 represents the spherical aberration which occurs due to a change in the diffraction angle caused by the diffractive structure pursuant to a unit wavelength change in the laser beam emitted from the light source, and SA2 represents the spherical aberration which occurs due to a change in the refractive index of the objective lens pursuant to a unit wavelength change in the laser beam emitted from the light source.

24. An objective lens made of resin provided in an optical head for recording or reproducing information to or from an information recording medium including three or more information recording surfaces,
the objective lens comprising:
an orbicular zone-shaped diffractive structure which diffracts a laser beam and converges the generated diffracted light of n-th order (where n is a natural number) on a predetermined information recording surface of the information recording medium, wherein
the diffractive structure adds a positive power component and a spherical aberration component to the n-th order diffracted light,
the spherical aberration component added by the diffractive structure has spherical aberration characteristics where the spherical aberration changes in a direction of under-correction when a wavelength of the laser beam shifts to a long-wavelength side, and
the spherical aberration component added by the diffractive structure satisfies following Formula (6):
0.8×|SA1|≦|SA2|1.2×|SA1| (6)
where, SA1 represents the spherical aberration which occurs due to a change in the diffraction angle caused by the diffractive structure pursuant to a unit wavelength change in the laser beam emitted from the light source, SA2 represents the spherical aberration which occurs due to a change in the refractive index of the objective lens pursuant to a unit wavelength change in the laser beam emitted from the light source, and SA1 and SA2 have polarities opposite to each other.

25. The objective lens according to claim 23,
wherein the objective lens reduces a change in the converged position of the laser beam which occurs pursuant to a wavelength change of the laser beam, and a variation D [μm/nm] of the converged position of the laser beam which occurs pursuant to a unit wavelength change in the laser beam satisfies following Formula (7):
0.05 [μm/nm]≦D≦0.15 [μm/nm] (7).

26. The objective lens according to claim 23,
wherein, when an optical path difference function Φ(h) which represents an addition of the optical path length caused by the diffractive structure is represented as
Φ(h)=P₂×h²+P₄×h⁴+P₆×h⁶+ . . . +P₂ₖ×h^{2k} (wherein k is a natural number), and a power φ_{D} of the lens caused by the diffractive structure is represented as φD=−(2×P₂×n×λ),
the power φ_{D} of the lens caused by the diffractive structure, and a power φ_{R} of an underlying refractive lens excluding the diffractive structure in the objective lens satisfy following Formula (8):
0.0040≦φ_{D}/φ_{R}≦0.020 (8)
where, h represents a height from an optical axis, n represents a diffractive order, P₂, P₄, P₆, . . . , P₂ₖ represent a coefficient, and λ represents a wavelength of the laser beam.
